(19) United States
(12) Patent Application Publication
(10) Pub. No.: US 2026/0181644 A1
(43) Pub. Date: Jun. 25, 2026

(54) PROCEDURES FOR RECEIVING RATE SPLIT DOWNLINK TRANSMISSION

(71) Applicant: InterDigital Patent Holdings, Inc., Wilmington, DE (US)

(72) Inventors: Omid Saatlou, Montreal (CA); Afshin Haghighat, Ile-Bizard (CA); Loic Canonne-Velasquez, Dorval (CA); Mohammad Irfan, Chateauguay (CA); Virgil Comsa, Montreal (CA); Moon IL Lee, Melville, NY (US)

(73) Assignee: InterDigital Patent Holdings, Inc., Wilmington, DE (US)

(21) Appl. No.: 18/990,484

(22) Filed: Dec. 20, 2024

(51) Int. Cl. H04W 72/23; H04B 7/0413; H04L 1/1812

(52) U.S. Cl. CPC H04W 72/23; H04B 7/0413; H04L 1/1812

(57) ABSTRACT

A WTRU may send an indication of a maximum number of RSMA layers and/or a maximum number of MIMO layers per RSMA layer. The WTRU may receive a first configuration associated with reception of common messages of rate splitting-based transmission (RS-based-T) and/or a second configuration associated with reception of WTRU-specific messages (WSM) of RS-based transmission. The first configuration may indicate CBG information associated with the common messages of RS-based-T. The second configuration may indicate CBG information associated with the WSM of RS-based-T. The WTRU may receive a downlink transmission that includes a RS-based common message and/or a RS-based WSM in accordance with the first and second configuration. The WTRU may transmit HARQ feedback for the downlink transmission that includes HARQ feedback for the RS-based common message and/or HARQ feedback for the RS-based WSM.

### BACKGROUND

Multiuser multiple input multiple output (MU-MIMO) support a large number of users with high data rate including delivery of broadcast/multicast (e.g. popular live events) and/or unicast (e.g. user personalized).

### SUMMARY

A wireless transmit/receive unit (WTRU) may be capable for rate splitting-based (RS-based) reception. Embodiments described herein may include one or more modes for generation of common data messages. Embodiments described herein may include one or more receiving procedures for common and/or private messages.

A WTRU may send capability information to a network. The capability information may include an indication of a maximum number of rate splitting multiple access (RSMA) layers and/or an indication of a maximum number of multiple input multiple output (MIMO) layers per RSMA layer. The WTRU may receive configuration information. The configuration information may include a first configuration and/or a second configuration. The first configuration may be associated with reception of common messages of rate splitting-based (RS-based) transmission. The second configuration may be associated with reception of WTRU-specific messages of RS-based transmission. The first configuration may indicate code block groups (CBGs) information associated with the common messages of RS-based transmission. The second configuration may indicate CBG information associated with the WTRU-specific messages of RS-based transmission. The WTRU may receive a downlink transmission. The downlink transmission may include at least one of a RS-based common message in accordance with the first configuration and/or a RS-based WTRU-specific message in accordance with the second configuration. The WTRU may transmit hybrid automatic repeat request (HARQ) feedback for the downlink transmission. The HARQ feedback may include at least one of HARQ feedback for the RS-based common message sent in accordance with the CBG information associated with the common message(s) indicated in the first configuration and/or HARQ feedback for the RS-based WTRU-specific messages sent in accordance with the CBG information associated with the WTRU-specific messages indicated in the second configuration.

The RS-based common message may include a plurality of CBGs formatted in accordance with the CBG information associated with the common message indicated in the first configuration and/or the RS-based WTRU-specific message may include a plurality of CBGs formatted in accordance with the CBG information associated with the WTRU-specific messages indicated in the second configuration.

The configuration information may include scheduling configuration information. The WTRU may determine an allocation of time and frequency resources based on the scheduling configuration information for each of the RS-based common message and/or the RS-based WTRU-specific message. The downlink transmission may be received in accordance with the allocation of time and frequency resources.

The configuration information may include scheduling configuration information. The WTRU may determine a first transmission rank associated with the common messages of RS-based transmission, a first modulation and coding rate associated with the common messages of RS-based transmission, a second transmission rank associated with the WTRU-specific based messages of RS-based transmission, and/or a second modulation and coding-rate associated with the WTRU-specific based messages of RS-based transmission. The downlink transmission may be received in accordance with one or more of the first transmission rank, the second transmission rank, the first modulation and coding-rate, or the second modulation and coding-rate.

The configuration information may include an initial power offset. The downlink transmission may be received based on the initial power offset. The WTRU may receive an indication indicating to update the initial (e.g., initially configured) power offset. The WTRU may update the initial (e.g., initially configured) power offset based on the indication.

The configuration information may include inter-user interference (IUI) values. The IUI values may include a first set of IUI values associated with the common messages of RS-based transmission. The IUI values may include a second set of IUI values associated with the WTRU-specific messages of RS-based transmission. The downlink transmission may be received based on the first and/or second set of IUI values.

The configuration information may include a configuration for a demodulation reference signal (DMRS) sequence. The DMRS sequence may include configuration for a first DMRS sequence and/or configuration for a second DMRS sequence. The first DMRS sequence may be associated with the common messages of RS-based transmission. The second DMRS sequence may be associated with the WTRU-specific messages of RS-based transmission. The downlink transmission may be received based on the first DMRS sequence and/or the second DMRS sequence.

The WTRU may include a first DMRS sequence initialization sequence and/or a second DMRS initialization sequence. The WTRU may use the first DMRS initialization sequence to receive the RS-based common message. The WTRU may use the second DMRS initialization sequence to receive the RS-based WTRU-specific message.

The WTRU of claim 1, wherein the configuration information comprises a radio network temporary identifier (RNTI), wherein the RNTI comprises a first RNTI and a second RNTI, wherein the first RNTI is associated with the common messages of RS-based transmission, and wherein the second RNTI is associated with the WTRU-specific messages of RS-based transmission, and wherein the downlink transmission is received based on the first RNTI or the second RNTI.

The WTRU may use different spatial filters to receive the RS-based common message(s) and/or the RS-based WTRU-specific message(s). The WTRU may receive a retransmission of the downlink transmission based on a determination that at least the common messages of RS-based transmission were not successfully received.

A base station may receive capability information from a wireless transmit/receive unit (WTRU). The capability information may include an indication of a maximum number of rate splitting multiple access (RSMA) layers and/or an indication of a maximum number of multiple input multiple output (MIMO) layers per RSMA layer. The base station may send configuration information to the WTRU. The configuration information may include comprises a first configuration and a second configuration. The first configuration may be associated with reception of common messages of rate splitting-based (RS-based) transmission. The second configuration may be associated with reception of WTRU-specific messages of RS-based transmission. The first configuration may indicate code block groups (CBGs) information associated with the common messages of RS-based transmission. The second configuration indicates CBG information may be associated with the WTRU-specific messages of RS-based transmission. The base station may send a downlink transmission to the WTRU. The downlink transmission may include at least one of a RS-based common message in accordance with the first configuration and/or a RS-based WTRU-specific message in accordance with the second configuration. The base station may receive hybrid automatic repeat request (HARQ) feedback for the downlink transmission. The HARQ feedback may include at least one of HARQ feedback for the RS-based common message sent in accordance with the CBG information associated with the common messages indicated in the first configuration and/or HARQ feedback for the RS-based WTRU-specific message sent in accordance with the CBG information associated with the WTRU-specific messages indicated in the second configuration.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of RS with a common part and a private part.

FIG. 3 depicts an example of RS architecture at the receiver side.

FIG. 4 depicts an example of modes for generation of common data.

FIG. 5 depicts an example of RS with Kₘₐₓ=2 and Lₘₐₓ=2.

FIG. 6 depicts an example of Mode A1.

FIG. 7 depicts an example of Mode A2.

FIG. 8 depicts an example of Mode B1.

FIG. 9 depicts an example of Mode B2.

FIG. 10 depicts an example of Mode C.

FIG. 11 depicts an example of retransmission request for common and private messages.

FIG. 12 depicts an example of when a wireless transmit/receive unit (WTRU) sends negative acknowledgement (NACK) for common transport blocks.

FIG. 13 depicts an example of when a WTRU sends acknowledgement (ACK) for common and NACK for private transport blocks.

FIG. 14 depicts an example of when a WTRU sends ACK for common and private transport blocks.

FIG. 15 depicts an example of when a code block group (CBG) is configured for private transport block.

### DETAILED DESCRIPTION

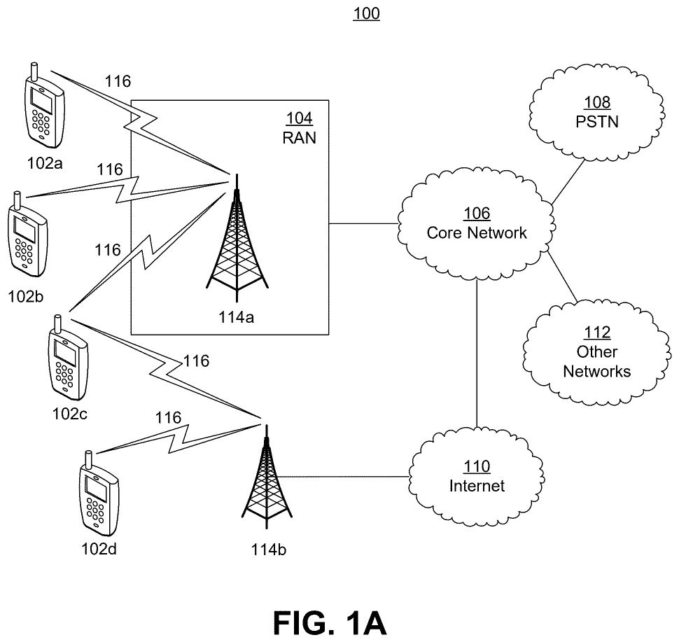

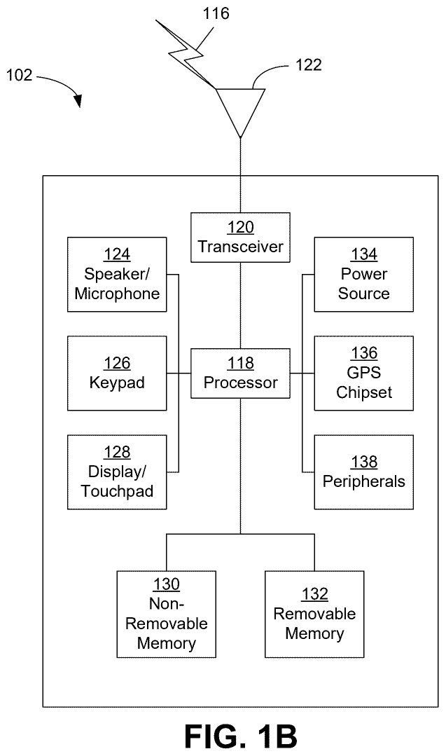

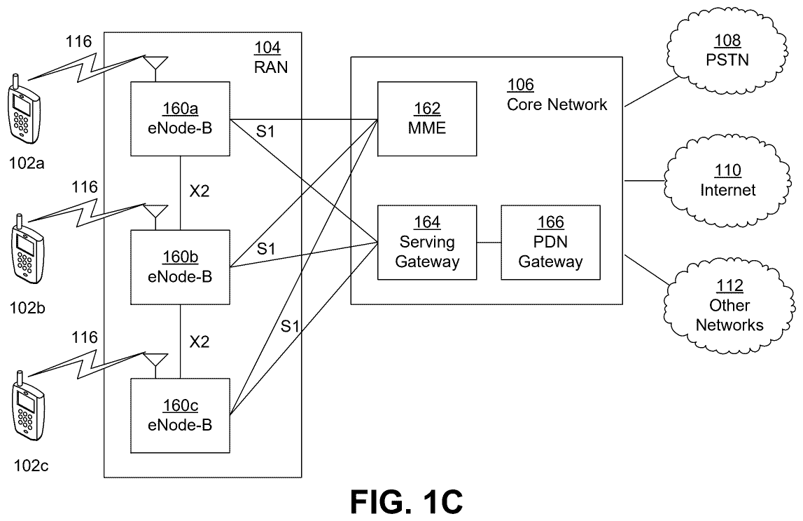

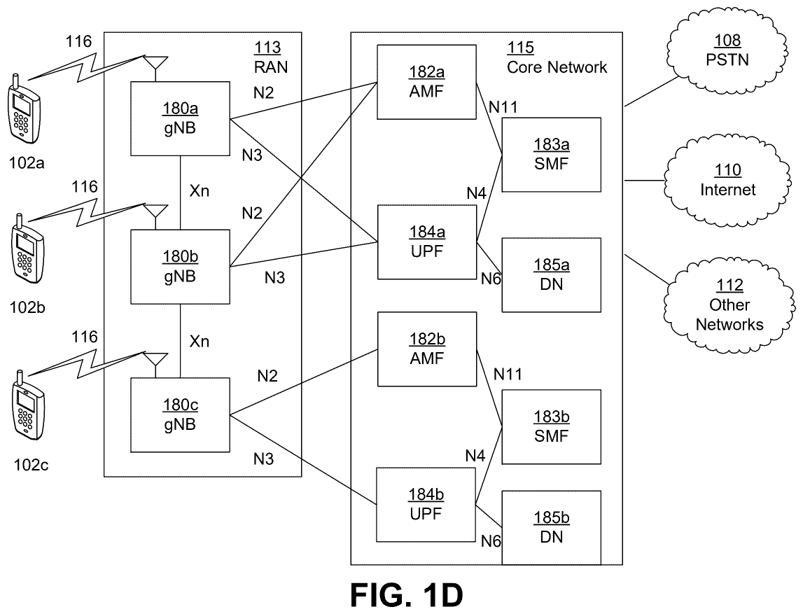

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Multiuser multiple input multiple output (MU-MIMO) support a large number of users with high data rate including delivery of broadcast/multicast (e.g. popular live events) and/or unicast (e.g. user personalized). One or more (e.g., some) feature embodiments may be studied on advanced MIMO techniques to enhance spectral efficiency (SE) of unicast (e.g., only) delivery, and/or joint unicast/multicast delivery. One of these embodiments may include rate splitting one or more (e.g., multiple) access (RS) for MU-MIMO.

A rate splitting-based (RS-based) transmission can be implemented in one or more (e.g., several) different ways. A transmitter may split the message into a common part and a private part as shown in FIG. 1. The terms common part and common portion may be used interchangeably herein. The terms private part, WTRU-specific part, private portion, WTRU-specific portion, dedicated portion, and/or dedicated part may be used interchangeably herein. Wᵢ may represent the data stream of i^{th} user splitting into the common part, e.g., W_{c,i} and the private part, e.g., W_{p,i}. A common message based on combining one or more (e.g., all) W_{c,i}'s may be produced and/or coded prior to transmission. Concurrently, each W_{p,i} may be independently coded and/or transmitted. This may means that one or more (e.g., all) users receive the common part in a common stream and/or the private part in a private stream that are superposed in a non-orthogonal manner. The common stream may be decodable by one or more (e.g., all) users; The private stream may (e.g., only) be decodable by the intended user.

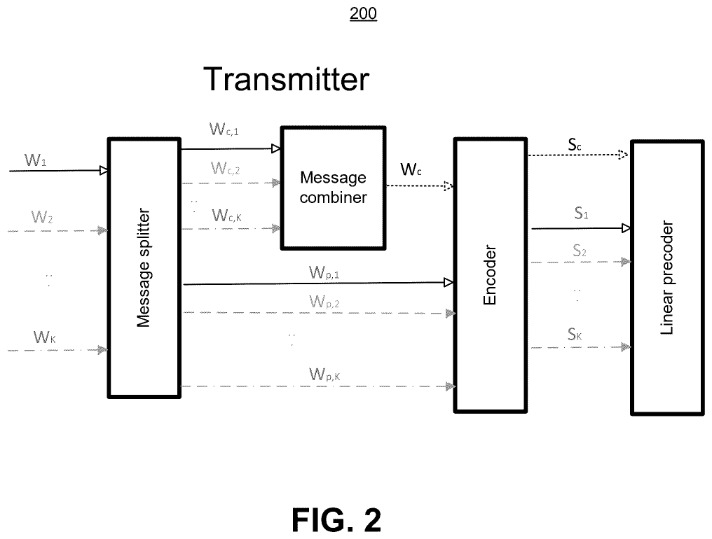

FIG. 2 depicts an example of RS with a common part and a private part 200.

One or more (e.g., conventional) multi-user multi-antenna approaches such as spatial division multiple access (SDMA)/MU-MIMO may (e.g., heavily) be based on timely and/or (e.g., highly) accurate channel state information (CSI) at transmitter (CSIT). CSIT may (e.g., always) be imperfect due to, for example, pilot reuse, channel estimation errors, pilot contamination, limited and/or quantized feedback accuracy, delay/latency, mobility (e.g., due to ever-increasing speeds of vehicle/trains/satellite/flying objects and/or emerging applications as Vehicle-to-Everything), radio frequency (RF) impairments (e.g., phase noise), inaccurate calibrations of RF chains, sub-band level estimation, and/or the like. SDMA/MU-MIMO may be (e.g., inherently) non-robust.

Rate splitting multiple access (RSMA) can be employed to design a robust MIMO wireless network that may account for imperfect CSIT and/or its corresponding interference. In an RSMA-based system, one or more (e.g., all) users may receive the common part in a common stream and/or the private part in a private stream tat are superposed in a non-orthogonal manner. At the receiver side, each WTRU may (e.g., first) decode the common data stream(s) of one or more (e.g., all) users using successive interference cancelation (SIC). Each WTRU may (e.g., then) decode its own private data stream by treating the interference as a noise. The terms private data stream, private data part, private part, private data message, and/or private message may be used interchangeably herein. For example, the terms private data stream, private data message, and/or private message, and/or private data part may refer to WTRU-specific data/message/stream. The terms common part, common data part, common data stream, common data message, and/or common message may be used interchangeably herein.

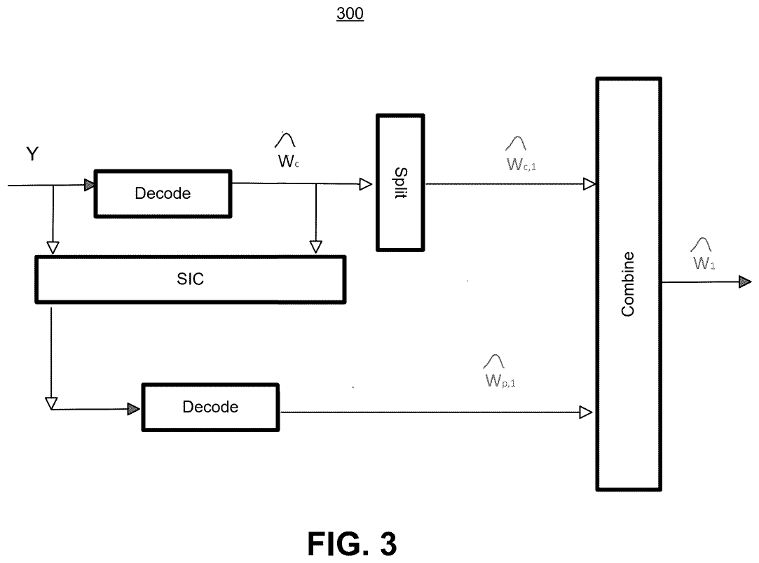

FIG. 3 depicts an example of the receiver architecture for RS for (e.g., only) user 1 and/or the other WTRUs may follow the same architecture 300.

A procedure for receiving and/or decoding the common and/or private message for the WTRU may play an (e.g., important) role to design such scheme. Embodiments may include one or more different aspects of designing RS-based downlink transmission. Embodiments may relate to one or more of: modes for generation of common data messages; hybrid automatic repeat request (HARQ)/code block group (CBG) configuration for common and/or private data messages; demodulated reference signal (DMRS) sequences for common and/or private data messages; and/or modulation and coding scheme (MCS) for different modes of common data messages.

RS approach may be employed for a downlink transmission. The data stream may be split to common and private parts. The common part of each WTRU can be combined in gNB and/or may be sent as a combined message. Embodiments described herein may include another (e.g., new) procedure that includes a WTRU configured to receive the RS message(s) and/or decode its own data stream. Embodiments may include decoding the different generation of common data streams, scheduling configuration for common and/or private messages, and/or applying HARQ/CBG configuration for common and/or private data messages.

A WTRU may perform one or more of the following procedures. A WTRU may report its capability for the support of RS-based reception. The WTRU may receive the mode of configuration for generation of common data messages. The WTRU may receive a scheduling configuration (e.g., a downlink control information). The scheduling configuration may include DMRS initialization sequence indices, an indication of modulation and/or coding, and/or an additional indication for correction of an initial power offset. The WTRU may receive HARQ/CBG configuration for common and/or private data messages and/or may report acknowledgement (ACK)/negative ACK (NACK) based on the configuration.

Embodiments for broadcast/multicast can be viewed as splitting the messages of each WTRU to two parts, including the common and private parts. This scheme may offer high throughput by mitigating the interference. A procedure for receiving and/or decoding the common and/or private messages for WTRU may play a (e.g., an important) role to design such a scheme.

Embodiments may include one or more procedures for receiving RS-based downlink transmission.

A WTRU may report its capability for RSMA-based reception. The capability report may include one or more of: a max number of RSMA layers layers (Kₘₐₓ) (e.g., max number of co-scheduled WTRUs per RSMA group); and/or a max number of MIMO layers (Lₘₐₓ) per RSMA layers. For example, a WTRU may report Kₘₐₓ=2 and Lₘₐₓ=2, by which 2 WTRUs, each with 2 MIMO layers, may be co-scheduled for a downlink RSMA transmission, where for each (e.g., every) layer of MIMO a common message and/or two private messages may be considered. For example, a WTRU may send capability information. The capability information may include an indication of a maximum number of rate splitting multiple access (RSMA) layers and/or an indication of a maximum number of multiple input multiple output (MIMO) layers per RSMA layer.

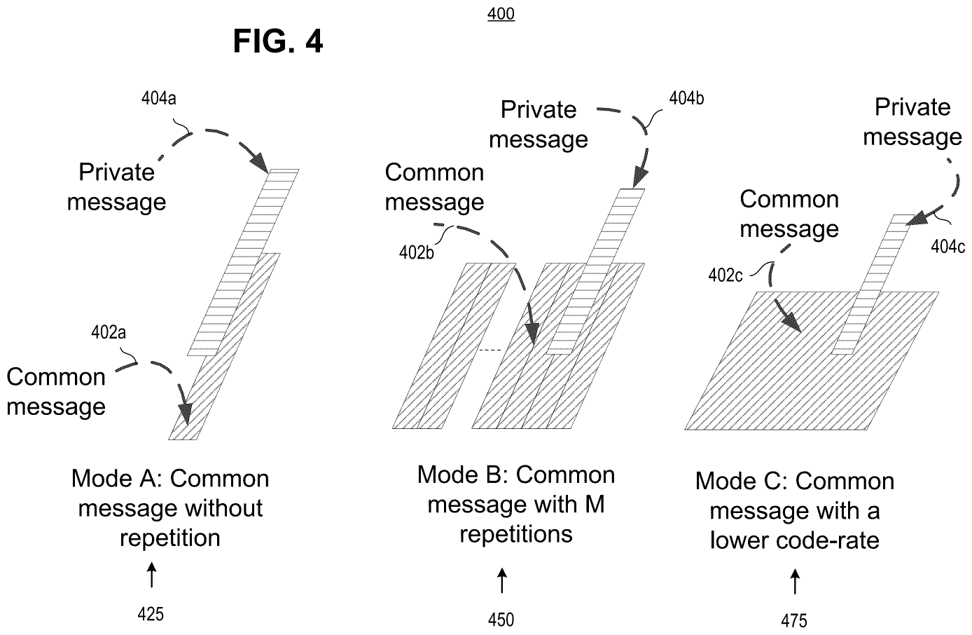

A WTRU may receive an indication (e.g., via radio resource control (RRC)) of one or more of the following. The WTRU may receive an indication of a mode for generation of common data message(s), as shown in FIG. 4. The mode may be mode A (e.g., common data message has the same code-rate as private data message), mode B (e.g., common data message may be generated by M repetitions, and/or each repetition may have the same code-rate as private data message), and/or mode C (e.g., common data message may have different code-rate (e.g., lower) than private data message). The WTRU may receive an indication of an initial power offset (α_{c}) between the common and private messages. The WTRU may receive an indication to use one or more codeblocks to form common messages. For example, when code block group (CBG) is configured, one or more codeblocks of a transport block may be used to form a common message. The WTRU may be configured with information for the interference cancelation of the co-scheduled WTRUs (e.g., a DMRS group sequence and/or sequence seed). For example, the WTRU may receive configuration information. The WTRU may receive the configuration information via radio resource control (RRC) (e.g., a RRC message). The configuration information may include a first configuration and/or a second configuration. The first configuration may be associated with reception of common messages of rate splitting-based (RS-based) transmission. The second configuration may be associated with reception of WTRU-specific messages of RS-based transmission. The first configuration may indicate CBGs information associated with the common messages of RS-based transmission. The second configuration may indicate CBG information associated with the WTRU-specific messages of RS-based transmission. The configuration information may include inter-user interference (IUI) values. The IUI values may include first set of IUI values associated with the common messages of RS-based transmission. The IUI values may include a second set of IUI values associated with the WTRU-specific messages of RS-based transmission.

The WTRU may receive a scheduling configuration (e.g., a DCI). The scheduling configuration may include one or more of the following. The scheduling configuration may include a first and/or a second information to determine time and/or frequency resource allocation used for transmission of common and/or private codewords. For the WTRUs having one or more (e.g., multiple) Rx chains, the WTRUs may receive a first and/or a second transmission configuration indicator (TCI) indication related to the common and/or private codewords. Additionally or alternatively, the WTRU may receive a single TCI indication that may be applicable to (e.g., both) common and/or private messages. The scheduling information may include a first and/or a second demodulation reference signal (DMRS) initialization sequence indices used for transmission of common and/or private codewords. DMRS sequences may be assigned based on RSMA layers and/or MIMO layers (common sequences and/or per WTRU). The WTRU may receive a scheduling configuration (e.g., a DCI) to indicate RSMA is employed for which MIMO layers (e.g., no RSMA may be employed for the remaining layers). DCI may indicate a common/group radio network temporary identifier (RNTI) for the common message to be used for descrambling while its RNTA may be used for private message part descrambling. The WTRU may receive an (e.g., additional) indication for correction of the initial power offset. For example, the configuration information may include scheduling configuration information. The WTRU may determine an allocation of time and/or frequency resources based on the scheduling configuration information for each of the RS-based common message(s) and/or the RS-based WTRU-specific message(s). The configuration information may include an initial (e.g., initially configured) power offset. The WTRU may receive an indication indicating to update the initial (e.g., initially configured) power offset. The WTRU may update the initial power offset based on the indication. The configuration information may include configuration for a DMRS sequence. The DMRS sequence may include configuration for a first DMRS sequence and/or a configuration for a second DMRS sequence. The first DMRS sequence may be associated with the common messages of RS-based transmission. The second DMRS sequence may be associated with WTRU-specific messages of RS-based transmission. The configuration information may include a first DMRS initialization sequence and/or a second DMRS initialization sequence. The configuration information may include a RNTI. The RNTI may include a first RNTI and/or a second RNTI. The first RNTI may be associated with the common messages of RS-based transmission. The second RNTI may be associated with WTRU-specific messages of RS-based transmission.

The WTRU may determine a first transmission rank associated with the common messages of RS-based transmission, a first modulation and coding-rate associated with the common message(s) of RS-based transmission, a second transmission rank associated with the WTRU-based message(s) of RS-based transmission, and/or a second modulation and coding-rate associated with the WTRU-specific messages of RS-based transmission.

The WTRU may receive an indication of modulation and/or coding. If the WTRU is configured in Mode A (e.g., as described herein), the WTRU may receive a single MCS index to determine the modulation/coding used for transmission of common and/or private message. If the WTRU is configured in Mode B (e.g., as described herein), the WTRU may receive a single MCS index to determine the modulation/coding used for transmission of common and/or private messages, and/or the WTRU may receive an index representing the number of repetitions (M) used for transmission of the common data message. If the WTRU is configured in Mode C, the WTRU may receive a first and/or a second MCS to determine the modulation/coding used for transmission of common and/or private messages.

The WTRU may receive a downlink transmission. The downlink transmission may include at least one of a RS-based common message in accordance with the first configuration and/or a RS-based WTRU-specific message in accordance with the second configuration. The RS-based transmission may include a plurality of CBGs formatted in accordance with the CBG information associated with the common message(s) indicated in the first configuration. The RS-based WTRU-specific message may include a plurality of CBGs formatted in accordance with the CBG information associated with the WTRU-specific messages indicated in the second configuration. The downlink transmission may be received in accordance with the allocation of time and/or frequency resources. The downlink transmission may be received based on the initial power offset. The downlink transmission may be received based on the first and/or second set of IUI values. The downlink transmission may be received based on the first DMRS sequence and/or the second DMRS sequence. The downlink may be received based on the first RNTI and/or the second RNTI. The downlink transmission may be received in accordance with one or more of the first transmission rank, the second transmission, the first modulation and coding-rate, and/or the second modulation and coding-rate. The WTRU may use the first DMRS initialization sequence to receive the RS-based common message(s). The WTRU may use the second DMRS initialization sequence to receive the RS-based WTRU-specific message(s).

The WTRU may demodulate and/or decode common and/or private messages. When codeblocks in common message have negative acknowledgement (NACK), for example, the WTRU may receive a transmission for (e.g., both) common and/or private messages. When codeblocks in common message have acknowledgement (ACK), for example, the WTRU may send ACK/NACK for codeblocks in private message(s). If codeblocks in private messages have NACK, the WTRU may receive a transmission for (e.g., both) common and/or private messages. When CBG is configured, the WTRU may send ACK/NACK (e.g., only) for codeblocks in private message(s). For example, the WTRU may transmit hybrid automatic repeat request (HARQ) feedback for the downlink transmission. The HARQ feedback may include at least one of HARQ feedback for the RS-based common message sent in accordance with the CBG information associated with the common messages indicated in the first configuration and/or HARQ feedback for the RS-based WTRU-specific message sent in accordance with the CBG information associated with the WTRU-specific messages indicated in the second configuration. The WTRU may transmit feedback (e.g., HARQ feedback) via one or more physical channels (e.g., physical uplink control channel (PUCCH), physical uplink shared channel (PUSCH)).

FIG. 4 depicts an example of modes for generation of common data message 400. For example, Mode A 425 illustrates common message 402a without repetition and private message 404a. For example, Mode B 450 illustrates common message 402b with M repetitions and private message 404b. For example, Mode C illustrates common message 402c with a lower code-rate and private message 404c.

A WTRU may report its capability for RSMA-based reception. The capability report may include one or more of: a max number of RSMA layers (Kₘₐₓ) (e.g., max number of co-scheduled WTRUs per RSMA group); and/or a max number of MIMO layers (Lₘₐₓ) per RSMA layers. For example, a WTRU may report Kₘₐₓ=2 and Lₘₐₓ=2, by which 2 WTRUs, each with 2 MIMO layers, may be co-scheduled for a downlink RSMA transmission, where for each (e.g., every) layer of MIMO a common message and/or two private messages may be considered. A WTRU may report a max number of Rx chains.

A WTRU may be configured by RRC with a maximum number of co-scheduled WTRUs per RS group, e.g., Kₘₐₓ, and/or a maximum number of MIMO layers per RS layers, e.g., Lₘₐₓ. Configuration information may indicate (e.g., indicated by the gNB and/or gNB scheduler) that the common messages of one or more (e.g., all) co-scheduled WTRUs may be combined for each layer as a unified common and/or each WTRU may perform decoding the unified common message(s) of one or more (e.g., all) co-scheduled WTRUs to decode the common message of each co-scheduled WTRU corresponding to each layer. Each WTRU may (e.g., then) perform successive interference cancelation to decode the private message(s) of each co-scheduled WTRU. For example, a WTRU may report Kₘₐₓ=2 and Lₘₐₓ=2, by which 2 WTRUs, each with 2 MIMO layers, may be co-scheduled for a downlink RSMA transmission.

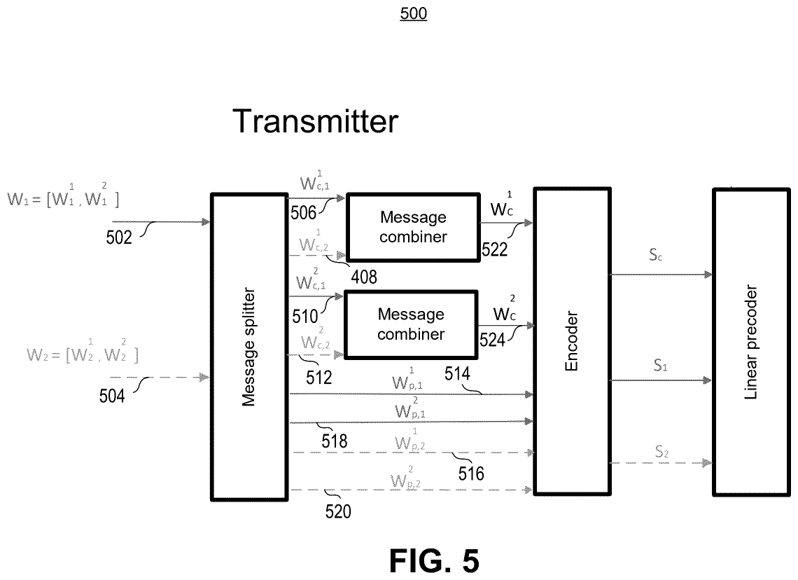

FIG. 5 depicts an example of RS layers at the transmitter 500 with Kₘₐₓ=2 and Lₘₐₓ=2. The WTRU may be configured with Kₘₐₓ=2 and

$${L}_{max} = 2 \cdot {W}_{i}^{j}$$

may refer to the jth message of user-i. In examples, the two data streams, e.g., W₁ 502 and/or W₂ 504 may be split into one or more (e.g., four) messages as shown herein:

$$\begin{matrix}{W}_{1}^{1} = \{ {W}_{c , 1}^{1} , {W}_{p , 1}^{1} \} ; {W}_{1}^{2} = \{ {W}_{c , 1}^{2} , {W}_{p , 1}^{2} \} ; {W}_{2}^{1} = \{ {W}_{c , 2}^{1} , {W}_{p , 2}^{1} \} ; and / or {W}_{2}^{= 2} \\ \{ {W}_{c , 2}^{2} , {W}_{p , 2}^{2} \} \cdot {W}_{c , 1}^{1}\end{matrix}$$

506 and

$${W}_{c , 2}^{1}$$

508 may be the common part of layer 1 from user 1 and user 2, respectively;

$${W}_{c , 1}^{2}$$

510 and

$${W}_{c , 2}^{2}$$

512 may be the common part of layer 2 from user 1 and user 2, respectively;

$${W}_{p , 1}^{1}$$

514 and

$${W}_{p , 2}^{2}$$

516 may be the private part of layer 1 from user 1 and user 2, respectively; and/or,

$${W}_{p , 1}^{2}$$

518 and

$${W}_{p , 2}^{2}$$

520 may be the private part of layer 2 from user 1 and user 2, respectively. As shown in FIG. 5, the common part of layer 1 from user 1 and user 2, e.g.,

$${W}_{c , 1}^{1}$$

506 and

$${W}_{c , 2}^{1}$$

508 may be combined as

$${W}_{c}^{1}$$

522. Similarly, for layer 2, the common part from user 1 and user 2 may be combined as

$${W}_{c}^{2}$$

524. The WTRU may (e.g., first) require to decode

$${W}_{c}^{1}$$

522 and/or

$${W}_{c}^{2}$$

524, and/or may (e.g., then) decode

$${W}_{p , 1}^{1}$$

514 and

$${W}_{p , 1}^{2}$$

516 using SIC.

The message combiner may operate as a cascade combiner and/or separately concatenate the common messages of layer 1 and layer 2, as shown in FIG. 4. A message combiner may be used to combine

$${W}_{c , 1}^{1}$$

506 and

$${W}_{c , 2}^{1}$$

508 for layer 1 and/or another message combiner may be used to combine

$${W}_{c , 1}^{2}$$

and

$${W}_{c , 2}^{2}$$

512 for layer 2. For example,

$${W}_{c , 1}^{1}$$

506 and

$${W}_{c , 2}^{1}$$

508 may include

$${L}_{c , 1}^{1}$$

bits and

$${L}_{c , 2}^{1}$$

bits, respectively. The length of common message may include

$${L}_{c , 1}^{1} + {L}_{c , 2}^{1}$$

bits. The WTRU may (e.g., first) receive a unified common message with L_{c,1}+L_{c,2} bits. The WTRU may decode the estimate of

$${W}_{c , 1}^{1}$$

506 and

$${W}_{c , 2}^{1}$$

508, e.g.,

$${\hat{W}}_{c , 1}^{1} and {\hat{W}}_{c , 2}^{1} ,$$

respectively. Using the

$${\hat{W}}_{c , 1}^{1} and {\hat{W}}_{c , 2}^{1} ,$$

the WTRU may may perform SIC to decode the estimate of

$${W}_{p , 2}^{1}$$

514 and

$${W}_{p , 1}^{1}$$

518, e.g.,

$${\hat{W}}_{p , 1}^{1} and {\hat{W}}_{p , 2}^{1} .$$

The WTRU may combine

$${\hat{W}}_{c , 1}^{1} and {\hat{W}}_{c , 2}^{1} . and {\hat{W}}_{p , 1}^{1} and {\hat{W}}_{p , 2}^{1}$$

to obtain the stream data of

$$\begin{matrix}{\hat{W}}_{1}^{1} = {\hat{W}}_{p , 1}^{1} + {\hat{W}}_{c , 1}^{1} and {\hat{W}}_{1}^{2} = {\hat{W}}_{p , 1}^{2} + \\ {\hat{W}}_{c , 1}^{2} ; {\hat{W}}_{1} = [ {\hat{W}}_{1}^{1} , {\hat{W}}_{1}^{2} ] .\end{matrix}$$

In examples, a message combiner may (e.g., first) encode

$${W}_{c , 1}^{1}$$

506 and

$${W}_{c , 2}^{1}$$

508 and/or may combine the encoded

$${W}_{c , 1}^{1}$$

506 and

$${W}_{c , 2}^{1}$$

508. In examples, the WTRU may receive the method of encoding to retrieve

$${\hat{W}}_{c , 1}^{1} and {\hat{W}}_{c , 2}^{1} .$$

In examples, the gNB may measure the inter-user interference IUI) and/or may design the common and/or private messages for one or more (e.g., all) WTRUs.

$${L}_{c , 1}^{1} and {L}_{c , 2}^{1}$$

may represent the length of common messages of User 1 and User 2 for layer 1;

$${L}_{c , 1}^{2} and {L}_{c , 2}^{2}$$

may represent the length of common messages of User 1 and User 2 for layer 2;

$${L}_{p , 1}^{2} and {L}_{p , 2}^{2}$$

may represent the length of private messages of User 1 and User 2 for layer 1; and/or

$${L}_{p , 1}^{2} and {L}_{p , 2}^{2}$$

may represent the length of private messages of User 1 and User 2 for layer 2. For example, the network may be configured with two IUI thresholds. For example,

$${IUI}_{th}^{1}$$

may indicate a low IUI, and/or IUI

$${IUI}_{th}^{2}$$

may indicate the high IUI, where IUI

$${IUI}_{th}^{1} < {IUI}_{th}^{2} .$$

If IUI is less than

$${IUI}_{th}^{1} ,$$

the common messages of WTRUs may be configured with (e.g., only) a small length

$$\begin{matrix}( e . g . , \\ {L}_{c , 1}^{1} ≪ {L}_{p , 1}^{1} ; {L}_{c , 1}^{2} ≪ {L}_{p , 1}^{2} ; {L}_{c , 2}^{1} ≪ {L}_{p , 2}^{1} ; and / or {L}_{p , 2}^{2} ) . If {IUI}_{th}^{1} < IUI < {IUI}_{th}^{2} ,\end{matrix}$$

the network may have flexibility to select one design among the following options:

$$\begin{matrix}Option 1 ( e . g . , {L}_{c , 1}^{1} < \\ {L}_{p , 1}^{1} ; {L}_{c , 1}^{2} < {L}_{p , 1}^{2} ; {L}_{c , 2}^{1} < {L}_{p , 2}^{1} ; and / or {L}_{c , 2}^{2} < {L}_{p , 2}^{2} ) ; Option 2 ( e . g . , {L}_{c , 1}^{1} > {L}_{p , 1}^{1} ; {L}_{p , 1}^{2} < {L}_{p , 1}^{2} ; \\ {L}_{c , 2}^{1} < {L}_{p , 2}^{2} ) ; and / or {L}_{c , 2}^{2} > {L}_{p , 2}^{2} ) ; Option 3 ( e . g . , {L}_{c , 1}^{1} < {L}_{p , 1}^{1} ; {L}_{c , 1}^{2} > {L}_{p , 1}^{2} ; {L}_{c , 2}^{1} > {L}_{p , 2}^{1} ; and / or ) \\ {L}_{c , 2}^{2} < {L}_{p , 2}^{2} ) ; and / or Option 4 ( e . g . , {L}_{c , 1}^{1} > {L}_{p , 1}^{1} ; {L}_{c , 1}^{2} < {L}_{p , 1}^{2} ; {L}_{c , 2}^{1} > {L}_{p , 2}^{1} ; and / or {L}_{c , 2}^{2} < {L}_{p , 2}^{2} ) .\end{matrix}$$

The four options may assist the network to design the common and/or private messages in such a way that IUI may be (e.g., significantly) mitigated. For example, the configuration information may include inter-user interference (IUI) values. The IUI values may include a first set of IUI values associated with the common messages of RS-based transmission. The IUI values may include a second set of IUI values associated with the WTRU-specific messages of RS-based transmission. The downlink transmission may be received based on the first and/or second set of IUI values.

$$If IUI > {IUI}_{th}^{2}$$

the common messages of WTRUs may be configured with a length comparable to private messages

$$( e . g . , {L}_{c , 1}^{1} < {L}_{p , 1}^{1} ; {L}_{c , 1}^{2} < {L}_{p , 1}^{2} ; {L}_{c , 2}^{1} < {L}_{p , 2}^{1} ; {L}_{c , 2}^{2} < {L}_{p , 2}^{2} ) .$$

A WTRU may configured with different cyclical redundancy check (CRC) for common and/or private parts by RRC. CRC may play an (e.g., important) role in ensuring the integrity and/or reliability of (e.g., both) the common and/or private messages that are transmitted to users. CRC can be designed for (e.g., both) the common and/or private messages to detect the bit errors of (e.g., both) messages. CRC may ensure that the data received by the WTRU is accurate for (e.g., both) common and/or private parts, which may allow for (e.g., appropriate) action to be taken if errors are detected. For example, the WTRU may request retransmission of each part that error is detected. For example, the WTRU may receive a retransmission of the downlink transmission based on a determination that at least the common messages of RS-based transmission were not successfully received. The WTRU may utilize error-correction techniques to correct the error part(s). When the base station broadcasts a common message to one or more (e.g., multiple) users, for example, a CRC can be appended to the common message. The CRC may be calculated based on the content of the common message before transmission. Each WTRU that receives the common message may (e.g., also) receive the associated CRC. After decoding the common message, for example, the WTRU may calculate the CRC based on the received data and/or may compare it to the CRC value received. If they match, for example, the message may be considered error-free; if not, it may indicate that an error has occurred.

For private message that are specific to individual WTRUs, CRC can (e.g., also) be applied. Each private message sent to a specific user may include its own CRC check to ensure its integrity. Similar to common messages, the WTRU may perform a CRC check on the received private message, which may help ensure that one or more (e.g., any) transmission errors are identified.

CRC may use a polynomial to generate the CRC bits. The choice of polynomial and/or parameters, such as the length of the CRC code, may influence the error-detecting capability. The WTRU may be configured with the choice of the polynomial and/or parameter(s), such as the length of the CRC code for (e.g., both) common and/or private messages. The WTRU may be configured with the choice of the polynomial and/or parameter(s) for each layer, such as the length of the CRC code for (e.g., both) common and/or private messages corresponding to each layer.

A computed CRC for a message may be mased by a sequence (e.g., an RNTI) that may be assigned to a WTRU (e.g., cell RNTI (C-RNTI)). For a WTRU configured to operate in RS mode, one or more of the following cases may be applied. A WTRU may be assigned a single RNTI value. The single RNTI value may indicate to the WTRU that a same RNTI (e.g., C-RNTI) may be applied for masking CRCs corresponding to (e.g., both) common and/or private messages. A WTRU may be assigned two RNTI values. The first RNTI value may be used for masking the common message; the second RNTI value may be used for masking the private message.

In examples, the first RNTI (e.g., for the common message) value may be indicated to N1 WTRUs. (e.g., broadcast); the second RNTI (e.g., for the private message) may be indicated to N2 WTRUs, where N2<N1. In examples, the first RNTI value (e.g., for the common message) may be indicated to a group of WTRUs configured in RS mode of operation; the second RNTI (e.g., for the private message) may be WTRU-specific.

Embodiments may include modes for generation of common data messages. A WTRU may receive an indication (e.g., via radio resource control (RRC)) of one or more of the following. The WTRU may receive an indication of a mode for generation of common data message(s), as shown in FIG. 4. The mode may be mode A (e.g., common data message has the same code-rate as private data message), mode B (e.g., common data message may be generated by M repetitions, and/or each repetition may have the same code-rate as private data message), and/or mode C (e.g., common data message may have different code-rate (e.g., lower) than private data message). The WTRU may receive an indication of an initial power offset (α_{c}) between the common and private messages. The WTRU may receive an indication to use one or more codeblocks to form common messages. For example, when CBG is configured, one or more codeblocks of a transport block may be used to form a common message.

The data for transmission may be split into a common part and a private part at the bit level, symbol level, code-block level, and/or at the codeword level. One or more of the following may apply. A symbol may be a representation of one or more bits. A code-block may be a representation of one or more symbols. A codeword may be a representation of one or more code-blocks and/or code-block groups and/or a codeword may (e.g., also) be referred to as a transport block. Embodiments described herein may include splitting the common and private data part. Embodiments may include application to the bit-level, code-block level, and/or codeword level.

In examples, the information bit stream (and/or symbols, and/or code-blocks, and/or codewords) may be split into a common and a private part based on one or more of the following. The information bit stream may be split based on the first, last, middle, and/or bits from one or more (e.g., any) arbitrary position(s) in the bit stream may be regarded and/or treated as common. For example, the initial split of the original data to common and private data may be arbitrary (e.g., the first 10 bits, the last 10 bits, etc.). Additionally or alternatively, the private part of the stream. For example, a bit stream may have 10 bits (e.g., 10 1 01 10 0 1 1). The last 3 bits (e.g., 01 1) may form a common message. For example, a bit stream may have 10 bits (e.g., 1 01 01 10 01 1). The first 3 bits (e.g., 1 01) may form a common message. The resulting bit streams may be denoted as Case A (e.g., private message: 1 01 01 10; common message: 0 1 1) and/or Case B (e.g., private message: 1 01 01 10 01 1; common message: 01 1).

In examples, the WTRU may receive a semi-static and/or dynamic configuration and/or an indication indicating the splitting of the data message (e.g., indicating one or more of the following). The WTRU may receive an indication indicating that the first and/or last M number of bits makes the common part. The WTRU may receive an indication indicating the integer value of M. The WTRU may receive an indication indicating Case A and/or Case B (e.g., as described herein).

In examples, the WTRU may change the bit retrieval behavior upon decoding based on Case A and/or Case B, M, and/or the indicators indicating the indexes of the private and/or the common part.

In examples, when Case B is configured, the WTRU may (e.g., only) send an ACK and/or NACK for private part and/or an ACK and/or NACK for the private part and/or the common part when Case A is configured. For example, Case A may include an indication of ACK and/or NACK sent for both common and private parts.

In examples, the common and/or the private data type may be generated based on the type of the combiner that the WTRU supports. For example, a WTRU may support Type-1, Type-2, and/or Type-3 combiner.

A WTRU may receive a semi-static and/or dynamic configuration and/or indication indicating the type of combiner to use. For example, the WTRU may receive an indication that indicates to use Type-1, Type-2, and/or Type-3 combiner.

Type-1 combiner may be described herein. The Type-1 combiner may not support private message part (e.g., only support common part). For example, the data of one or more WTRUs may be multiplexed in power domain and/or multiplexed in code-domain, which may result in a single message signal. For example, two messages (e.g., s₁ and s₂) may be multiplexed in power domain as s=p₁s₁+p₂s₂, where p₁ may be the power allocated to the first symbol and/or p₂ may be the power allocated to the second symbol. For example, the WTRU may determine s₁ and/or s₂ based on the received s and/or based on p₁ and p₂, e.g., the WTRU may (e.g., first) decode s₂ from s and/or may (e.g., then) determine s₁ as s₁=s−s₂. For example, when Type-1 combiner is configured, the transmission behavior of the transmitter and/or the reception behavior of the receiver may behave similar to non-orthogonal multiple access operations.

Type-2 combiner may be described herein. When using Type-2 combiner, the private message part may be the user's data message and/or the common data part may be a broadcast message (e.g., a master information block (MIB), a system information block (SIB), SIB1, SIB2, on-demand SIB, etc.).

Type-3 combiner may be described herein. When using Type-3 combiner, the WTRU may not expect to receive a common message part (e.g., the WTRU may only receive private message part using one or more beams and/or layers.

A WTRU may be configured with different modes for generation of common data message and/or the initial power offset (α_{c}) between the common and private message, which may allow for more efficient use of resources and/or reduced signaling overhead. In RS approach, the common messages may be robustly received by the WTRU to detect the private messages. The WTRU may not be able to detect the whole message (e.g., private message+common messages) and/or may send a request retransmission. To design the robust common data messages, the generation of common data messages may be based on one or more of the following: Mode A (e.g., Mode A1, Mode A2); Mode B (e.g., Mode B1, Mode B2); and/or Mode C.

Mode A may include common data message having the same code-rate as private data message. The initial power offset (α_{c}) may be configured in such a way that the WTRU is able to detect the common messages, as shown in FIG. 5. Mode A can be presented in two following modes in time and frequency. Additionally or alternatively, the common message may have a different code-rate (e.g., a lower code rate than the private message).

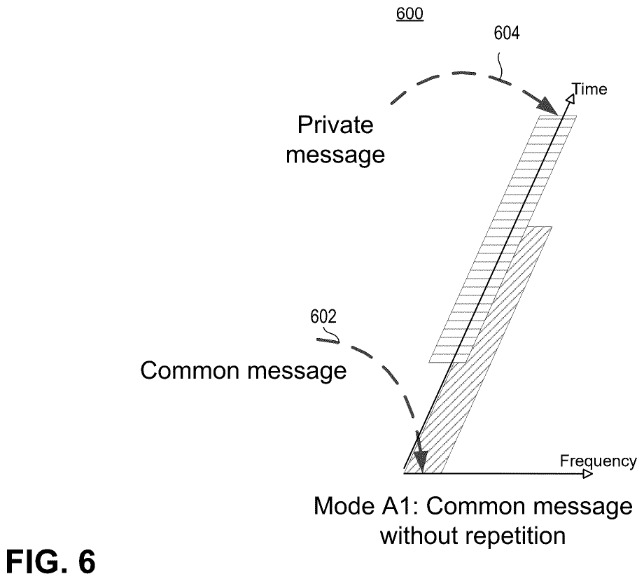

FIG. 6 depicts an example of Mode A1 600: common data (e.g., common message 602) and private messages (e.g., private message 604) may be in a same frequency but in different time.

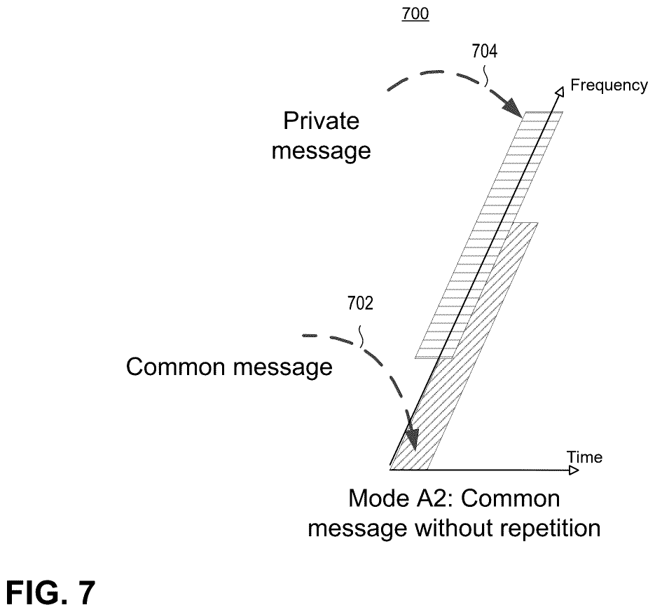

FIG. 7 depicts an example of Mode A2 700: common data (e.g., common message 702) and private messages (e.g., private message 704) may be in a same time but different frequency.

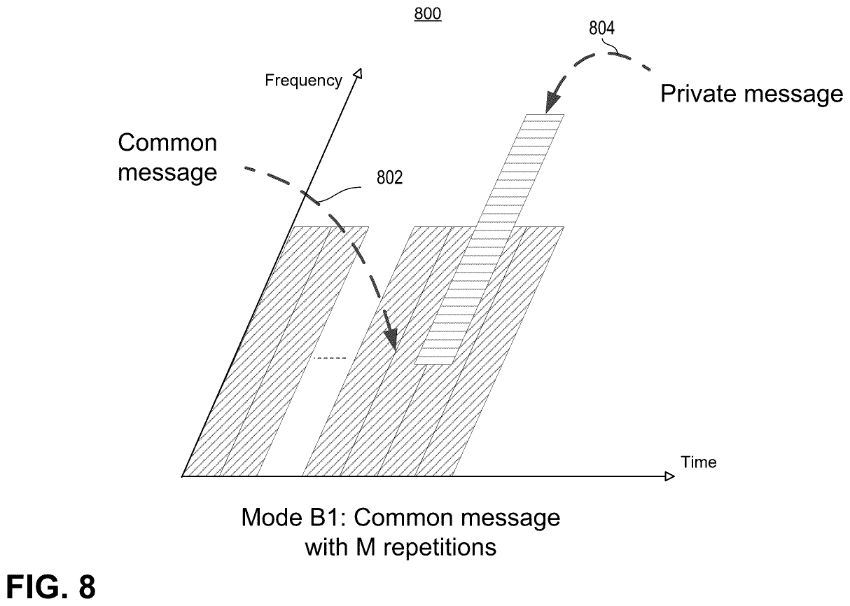

Mode B may include common data generated by M repetitions. Each repetition may have the same code-rate as private data messages, as shown in FIGS. 8 and/or 9. A WTRU may receive the common messages more robustly than private messages (e.g., though receive combining). For example, at the WTRU, one or more (e.g., multiple) received copied of the message may be combined to give a higher SNR. Transmission of the common message may be more robust (e.g., higher power, stronger coding, etc.) Mode B can (e.g., also) be presented as the following two modes: Mode B1 and/or Mode B2.

FIG. 8 depicts an example of Mode B1 800. In Mode B1, common data (e.g., common message 802) may be generated by M repetitions in time where each repetition may have the same code-rate as private data message (e.g., private message 804).

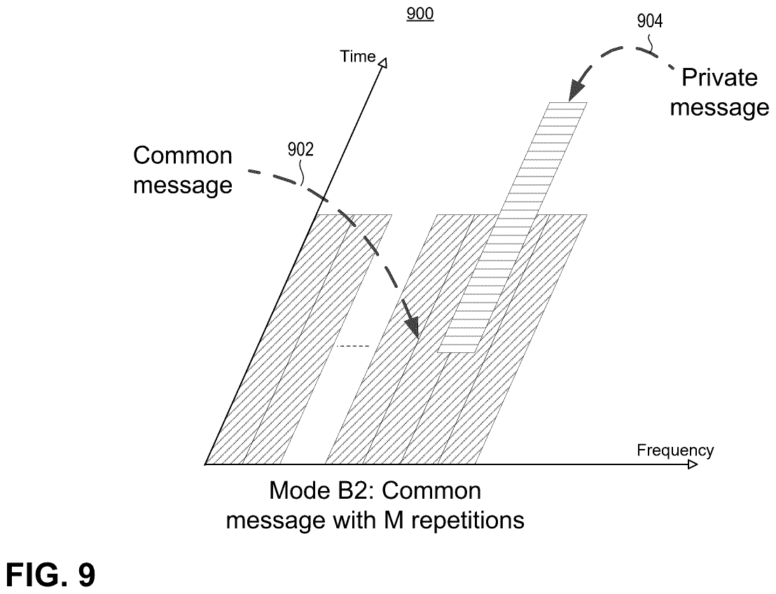

FIG. 9 depicts an example of Mode B2 900. In Mode B2, common data (e.g., common message 902) may be generated by M repetitions in frequency, where each repetition may have the same code-rate as private data message (e.g., private message 904).

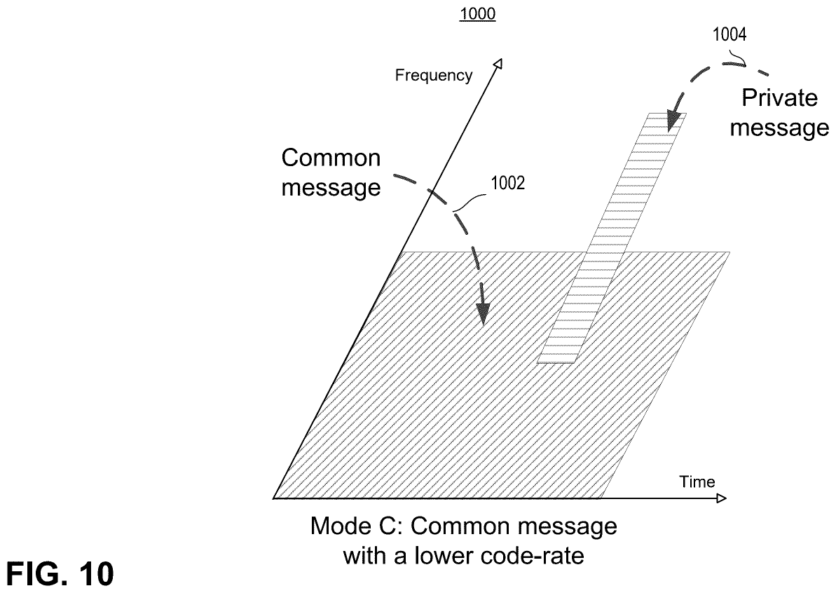

FIG. 10 depicts an example of Mode C 1000. In Mode C, common data message (e.g., common message 1002) may have a different code rate (e.g., lower) than that of private data message (e.g., private message 1004). To design such a system, as shown in FIG. 10, common data messages may be generated taking more time and frequency resources than private messages (e.g., as shown in FIG. 10).

Embodiments may include receiving procedures for common and/or private messages.

The WTRU may receive a scheduling configuration (e.g., a DCI). The scheduling configuration may include one or more of the following. The scheduling configuration may include a first and/or a second information to determine time and/or frequency resource allocation used for transmission of common and/or private codewords. The scheduling information may include a first and/or a second DMRS initialization sequence indices used for transmission of common and/or private codewords. DMRS sequences may be assigned based on RSMA layers and/or MIMO layers (common sequences and/or per WTRU). The WTRU may receive a scheduling configuration (e.g., a DCI) to indicate RSMA is employed for which MIMO layers (e.g., no RSMA may be employed for the remaining layers). The WTRU may receive an (e.g., additional) indication for correction of the initial power offset. For example, the configuration information may include scheduling configuration information. The WTRU may determine an allocation of time and/or frequency resources based on the scheduling configuration information for each of the RS-based common message(s) and/or the RS-based WTRU-specific message(s). The configuration information may include an initial (e.g., initially configured) power offset. The WTRU may receive an indication indicating to update the initial (e.g., initially configured) power offset. The WTRU may update the initial power offset based on the indication. The configuration information may include configuration for a DMRS sequence. The DMRS sequence may include configuration for a first DMRS sequence and/or configuration for a second DMRS sequence. The first DMRS sequence may be associated with the common messages of RS-based transmission. The second DMRS sequence may be associated with WTRU-specific messages of RS-based transmission. The configuration information may include a first DMRS initialization sequence and/or a second DMRS initialization sequence. The configuration information may include a RNTI. The RNTI may include a first RNTI and/or a second RNTI. The first RNTI may be associated with the common messages of RS-based transmission. The second RNTI may be associated with WTRU-specific messages of RS-based transmission.

The WTRU may determine a first transmission rank associated with the common messages of RS-based transmission, a first modulation and coding-rate associated with the common message(s) of RS-based transmission, a second transmission rank associated with the WTRU-based message(s) of RS-based transmission, and/or a second modulation and coding-rate associated with the WTRU-specific messages of RS-based transmission.

The WTRU may receive a downlink transmission. The downlink transmission may include at least one of a RS-based common message in accordance with the first configuration and/or a RS-based WTRU-specific message in accordance with the second configuration. The RS-based transmission may include a plurality of CBGs formatted in accordance with the CBG information associated with the common messages indicated in the first configuration. The RS-based WTRU-specific message may include a plurality of CBGs formatted in accordance with the CBG information associated with the WTRU-specific messages indicated in the second configuration. The downlink transmission may be received in accordance with the allocation of time and/or frequency resources. The downlink transmission may be received based on the initial power offset. The downlink transmission may be received based on the first and/or second set of IUI values. The downlink transmission may be received based on the first DMRS sequence and/or the second DMRS sequence. The downlink may be received based on the first RNTI and/or the second RNTI. The downlink transmission may be received in accordance with one or more of the first transmission rank, the second transmission rank, the first modulation and coding rate, and/or the second modulation and coding-rate. The WTRU may use the first DMRS sequence to receive the RS-based common message(s). The WTRU may use the second DMRS initialization sequence to receive the RS-based WTRU-specific message(s).

The WTRU may receive an indication of modulation and/or coding. If the WTRU is configured in Mode A (e.g., as described herein), the WTRU may receive a single MCS index to determine the modulation/coding used for transmission of common and/or private message. If the WTRU is configured in Mode B (e.g., as described herein), the WTRU may receive a single MCS index to determine the modulation/coding used for transmission of common and/or private messages, and/or the WTRU may receive an index representing the number of repetitions (M) used for transmission of the common data message. If the WTRU is configured in Mode C, the WTRU may receive a first and/or a second MCS to determine the modulation/coding used for transmission of common and/or private messages.

A WTRU may receive a scheduling configuration (e.g., a DCI). The scheduling configuration may include the generation modes of common and/or private codewords (e.g., as described herein) and/or the first and/or second DMRS initialization sequence indices used for transmission of common and/or private codewords. DMRSs may be specifically designed to enable the WTRU to estimate the channel condition(s). This may be used for RS measurement(s) because, for example, separately configurable DMRS initialization parameters for common and/or private message may be used (e.g., concurrently). For instance, different DMRS configurations may be used to transmit (e.g., both) common and/or private messages to one or more (e.g., multiple) users. Accurate channel estimation may help in mitigating interference and/or ensuring that each user can correctly decode the received common and/or private message(s).

In examples, each WTRU may be configured with a DMRS sequence for the common message and a different DMRS sequence for its own private message. If a WTRU is configured with L layers, where 1<L<Lₘₐₓ, for example, the WTRU may be configured with different DMRS sequences corresponding to each layer for (e.g., both) common and/or private messages. The WTRU may be configured with a DMRS sequences corresponding to layers 1:[L/2] for both common and private messages and/or a different DMRS sequences corresponding to layers [L/2]+1:L for both common and private messages.

In examples, one or more (e.g., all) co-scheduled WTRUs may be configured with a DMRS sequence for the common message and a different DMRS sequence for its own private message. If a WTRU is configured with L layers, 1<L<Lₘₐₓ for example, the WTRU may be configured with different DMRS sequences corresponding to each layer for (e.g., both) common and/or private messages. The WTRU may be configured with a DMRS sequences corresponding to layers 1:[L/2] for both common and private messages and/or a different DMRS sequences corresponding to layers [L/2]+1:L for both common and private messages.

In examples, each WTRU may be configured with a DMRS sequence for the common message and one or more (e.g., all) co-scheduled WTRUs may be configured with the same DMRS sequence for its own private message. If a WTRU is configured with L layers, 1<L<Lₘₐₓ for example, the WTRU may be configured with different DMRS sequences corresponding to each layer for (e.g., both) common and/or private messages. The WTRU may be configured with a DMRS sequences corresponding to layers 1:[L/2] for both common and private messages and/or a different DMRS sequences corresponding to layers [L/2]+1:L for both common and private messages.

In examples, each WTRU may be configured with a DMRS sequence for the common message and a DMRS sequence for its own private message. The two sequences for common and private messages may be common for one or more (e.g., all) co-scheduled WTRUs. If a WTRU is configured with L layers, 1<L<Lₘₐₓ for example, the WTRU may be configured with different DMRS sequences corresponding to each layer for (e.g., both) common and/or private messages. The WTRU may be configured with a DMRS sequences corresponding to layers 1:[L/2] for both common and private messages and/or a different DMRS sequences corresponding to layers [L/2]+1:L for both common and private messages.

In examples, the number of resource elements allocated for DMRS sequences can vary for common and/or private messages. For example, one DMRS symbol may be allocated per resource block for private message transmission, while a common message may include DMRS that can be utilized by one or more (e.g., multiple) users.

In examples, the number of DMRS symbols can (e.g., also) be adjusted based on the channel estimation requirements and/or resource allocation strategies for (e.g., both) common and/or private messages. The use of one or more (e.g., multiple) DMRS symbols can provide improved estimation, especially in scenarios with high IUI. For example, the number of DMRS symbols for common codewords can be less than the number of DMRS symbols for private codewords. In examples, the number of DMRS symbols for common codewords can be less than the number of DMRS symbols for private codewords associated with each layer.

When a WTRU is configured with L layers, for example, the WTRU may receive a scheduling configuration (e.g., a DCI) and/or an indication (e.g., L^{rs}) where the indication in the DCI may include the layers that their messages are split to two parts, a common message and a private message. The WTRU may be configured with L−L^{rs}, where the messages may not follow the RS approach; the WTRU may receive L−L^{rs} unified message. The WTRU may decode L^{rs} layers using the RS approach, as shown in FIG. 3, and/or may decode L−L^{rs} layers with non-RS approach. In examples, the WTRU may receive the L^{rs} layers with a different MCS from L−L^{rs} layers. For example, a WTRU may receive a DCI for decoding of private message with a MCS and/or decoding of common message with (e.g., another) MCS for the L^{rs} layers. One of these two MCSs (e.g., to decode the common and private message(s)) may be same or different for decoding L−L^{rs} layers using non-RS. In examples, a WTRU may receive a DCI for decoding of private message with a MCS and decoding of common message with the same MCS for the L^{rs} layers. This MCS may be same/different for decoding L−L^{rs} layers using non-RS.

A WTRU may receive two scheduling configurations (e.g., two separate DCIs—a first DCI for common codewords and a second DCI for private codewords). The first DCI may indicate that the WTRU receives the second DCI for the private messages so that the first and second DCIs are associated. For example, a DCI for the common message and/or a (e.g., another) DCI for the private message may indicate the MCS, number of layers, resource block allocation, and/or DMRS sequences for the common and private codewords, respectively. In examples, the first DCI may indicate the information for decoding the common codewords (e.g., the MCS, number of layers, resource block allocation and/or DMRS sequences and/or a portion of the information for decoding the private codewords (e.g., MCS, number of layers, resource blocks, DMRS sequences, etc.). In examples, to reduce the DCI bits, the first DCI may indicate that MCS, number of layers and/or DMRS sequences for the common codewords may be the same as the private codewords in the second DCI. The second DCI may indicate (e.g., only) the resource blocks in private codewords with less number of bits than the first DCI.

A WTRU may receive a scheduling configuration (e.g., a DCI), where the scheduling information may include an additional indication for correction of the initial power offset

$$( {α}_{c}^{′} )$$

and/or a Δ value to adjust the initial power offset, e.g.,

$${α}_{c}^{′} = {α}_{c} \pm Δ .$$

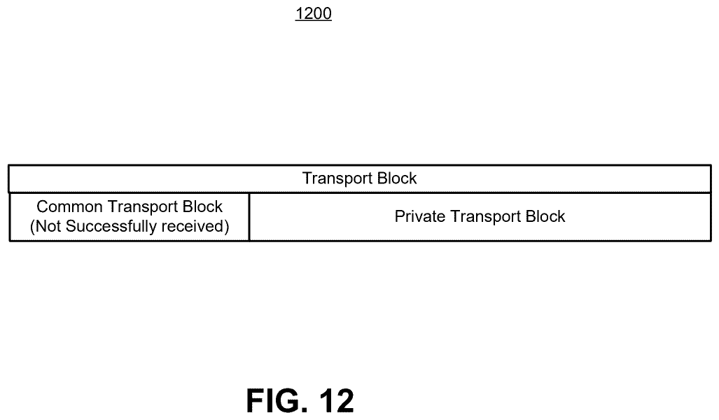

By adjusting the power levels, for example, the network can (e.g., effectively) manage the reliability and/or quality of the common and/or private codewords. In the RS approach, the WTRU may require to decode the common messages with a high reliability to be able to decode the private messages. The WTRU may send a retransmission request over (e.g., both) the common messages and/or private messages, as shown in FIG. 12. To reliably decode the whole messages and/or reduce the transmission request overhead, for example, the WTRU may require receiving and/or decoding the common messages with a low block error rate (BLER).

In examples, a WTRU may report back the channel conditions to the gNB (e.g., CQI providing insights into how well the common and/or private messages are received). The gNB can use this feedback to adjust the power offset for subsequent transmission(s).

In examples, the power offset can be adjusted using predefined power control algorithms that take into account the estimated path loss, the interference conditions, and/or the required quality of service (QoS) for the common and/or private messages.

In examples, the power offset can be adjusted using a reference signal. The reference signal utilized for the common message might be set at a certain power level, while the power for the private message can be adjusted relative to that reference. This may create a systematic approach to managing power levels to achieve desired performance.

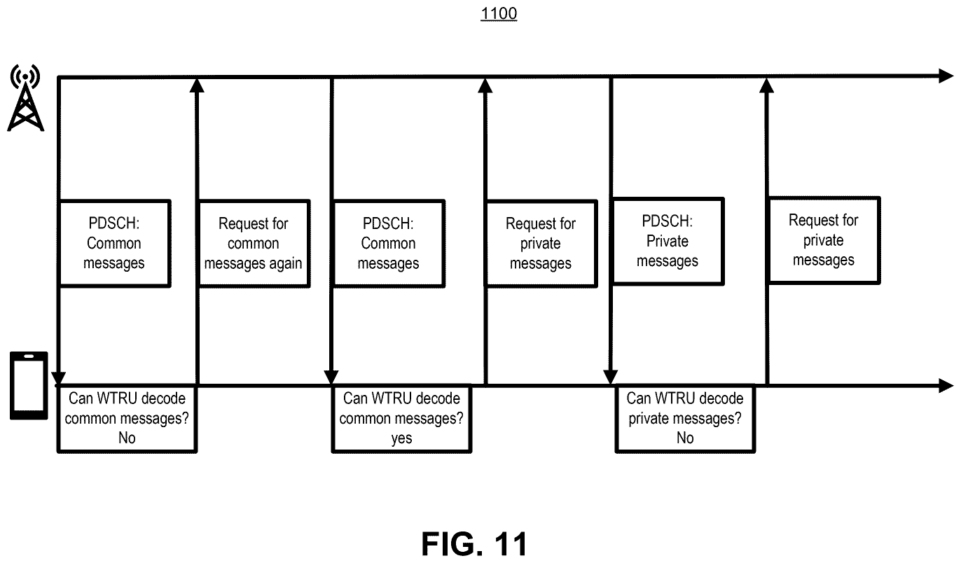

FIG. 11 depicts an example of retransmission request for common and/or private messages 1100.

In examples, the additional power offset value can be different among the modes (e.g., as described herein). Additionally or alternatively, the messages transmitted on the same resources can interfere with each other among the co-scheduled WTRUs. By adjusting the power offset, the network can minimize the impact of interference on the private message while (e.g., still) maintaining a (e.g., reasonable) signal level for the common message.

If a WTRU is configured with Mode A, a WTRU may (e.g., also) be configured with a +Δ value to apply more power in common messages and/or a MCS index for transmission of common and/or a MCS index for transmission of private messages. Since there may be no repetition for common messages in Mode A, for example, by applying a high-power level to common messages, the WTRU may be able to decode the common data messages.

If a WTRU is configured with Mode B, the WTRU may (e.g., also) be configured with M repetitions' value indicating the number of common message repetitions. In examples, the WTRU may be configured with a same power offset

$${α}_{c}^{′}$$

for one or more (e.g., all) common messages and/or with a different power offset

$${α}_{c}^{′}$$

for each repetition. Additionally or alternatively, the WTRU may be configured with a MCS index for transmission of private messages and/or a MCS index for transmission of each iteration of common message and/or a MCS index for one or more (e.g., all) iterations of common message. By applying a high-power level to common messages, for example, the WTRU may be able to decode the common data messages. If the CQI of common messages are greater than a threshold indicating that the channel quality of common messages is strong enough to be decoded with a high probability, for example, the WTRU may be configured with a high-power level to private messages.

If the WTRU is configured with Mode C, the WTRU may (e.g., also) be configured with a power offset

$${α}_{c}^{′}$$

for common messages and/or a MCS index for transmission of common and/or a MCS index for transmission of private messages. This may help that common data message may have a lower code-rate than private data message and/or may make sure that the common data messages are accurately decoded.

In examples, the WTRU may send (e.g., periodically, aperiodically), a feedback report for the gNB to adjust the power offset with ±Δ. The value Δ may be designed based on power control algorithms in gNB. This may help to minimize BLER.

A WTRU may determine the association of separate DCIs for common and private messages.

In examples, a WTRU may receive separate resource grants (e.g., DCIs) transmitted in separate time/frequency resources, which may separately indicate the scheduling/resource allocation of common and/or private messages. Resource allocation may include time resources (e.g., symbols, slots, frames), frequency resources (e.g., resource blocks (RBs), bandwidth parts (BWPs), carriers, subcarrier spacing (SCS)), and/or spatial resources (e.g., beam, transmission configuration indicator (TCI), precoder, beamformer, antennas, spatial filters).

A first DCI may indicate the resource allocation for the common message part. A second DCI may indicate the resource allocation for the private message part. A WTRU may be required to monitor a set of physical downlink control channel (PDCCH) candidates in one or more control resource sets (CORESETs), where monitoring may imply receiving a PDCCH candidate and/or decoding it according to a monitored DCI format for the first DCI and/or the second DCI. A WTRU may be expected to monitor for the first DCI (e.g., associated with the common part grant) before monitoring and/or decoding the second DCI (e.g., associated with the private part grant).

The WTRU may determine that the first and second DCI are linked according to one or more (e.g., a combination) of the following.

In examples, the first DCI may be send on a common search space (CSS) set, where the DCI may be scrambled with a group-common and/or broadcast and/or multicast RNTI, which may be decoded by more than one WTRU. The group-common RNTI may be RRC configured to the WTRU based on the WTRU reporting a capability to support RS-based downlink transmissions. The second DCI may be transmitted over a WTRU-specific search space (USS) set, where the second DCI may be scrambled with a WTRU-specific search RNTI (e.g., C-RNTI). Additionally or alternatively, the WTRU may determine the RNTI for monitoring the second DCI as a function of the contents of the first DCI, where the first DCI may indicate the WTRU-specific RNTI and/or a set of parameters to derive the WTRU-specific RNTI. For example, the WTRU-specific RNTI may include the group-common RNTI plus x, where x may be derived WTRU-specifically (e.g., based on an indicator in the first DCI's content.).

In examples, a WTRU may be configured with two separate set of CORESET resources (e.g., a CORESET resource may include a CORESET ID, coresetPoolIndex, CCE, REG where a CORESET ID includes one or more CCEs where each CCE may be made up of REG, where each REG may be a time/frequency unit of 1 RB and/or 1 symbol), where set 1 and/or 2 may be associated to a first and/or a second DCI, respectively. For example, the WTRU may monitor for a first DCI on a first CORESET resource, and/or for a second DCI on a second DCI resource. The WTRU may (e.g., explicitly) be configured with an RRC parameter which indicates the index of CORESET resources that are linked for the DCIs of common and/or private parts (e.g., CORESETs linked together). The WTRU may receive a medium access control control element (MAC-CE) to activate and/or deactivate the link(s) between CORESET resources. Similarly, instead of CORESET resources, two search space sets may be configured, where set 1 and set 2 may be associated to a first and second DCI, respectively, and/or the same rules may apply for linkage (e.g., explicitly RRC configured). Each search space may be associated with an AL. For example, search space with an AL=4 may be associated with the first DCI, and/or search space with an AL=2 may be associated with the second DCI. The AL may indicate the number of CCEs (e.g., 4 or 2) to monitor.

In examples, the first DCI may include details to assist the WTRU in monitoring the second DCI. The first DCI may include time/frequency/spatial resources where the WTRU may monitor for the second DCI (e.g., BWP, carrier, CORESET, search space). For example, the WTRU may monitor the first DCI on the first BWP and/or the first DCI may indicate to monitor for the second DCI on a CORESET located on a second BWP. The BWP associated to the second DCI may be (e.g., explicitly) indicated in the first DCI's content; additionally or alternatively, the WTRU may be (pre)configured with an association between a BWP index and a first and/or second DCI. For example, the WTRU may be configured to monitor for the first DCI on a first BWP, and/or to monitor for the second DCI on a second BWP.

The WTRU may monitor for the first and/or second DCI on different spatial filters (e.g., transmission configuration indicators (TCIs)). For example, the WTRU may use different spatial filters to receive the RS-based common message(s) and/or the RS-based WTRU-specific message(s). The WTRU may be configured with a TCI to receive the first DCI (TCI_DCI1). The first DCI may include two fields for spatial filter indication: one TCI may indicate the spatial filter to receive the common message part that is scheduled by the first DCI (TCI_common), and/or a second TCI may indicate the spatial filter to monitor the second DCI (TCI_DCI2). The second DCI may indicate the TCI to receive the private part (TCI_private). For example, the WTRU may monitor for the first DCI using TCI_DCI1. Based on (e.g., after) decoding the first DCI, for example, the WTRU may receive the common message part on a physical downlink shared channel (PDSCH) that is transmitted with TCI_common, and/or the WTRU may determine to monitor for the second DCI using TCI_DCI2. Based on (e.g., after) decoding the second DCI, for example, the WTRU may receive the private message part on a PDSCH that is transmitted with TCI_private. Additionally or alternatively, the first DCI may include the TCI state(s) for the common and/or private parts (e.g., TCI_common and/or TCI_private).

If one or more of the DCIs do not include a field with an (e.g., explicit) TCI state (e.g., TCI_common and/or TCI_private are not indicated), for example, the WTRU may determine the TCI(s) to receive the second DCI and/or the common data and/or the private data part based on a default rule for TCI selection. The rule may be based on using: the TCI state of the lowest CORESET ID in the search space where the first DCI is monitored; the lowest TCI state ID applicable to the PDSCH of the common part; and/or the TCI state used to receive the first DCI.

In examples, a WTRU may apply the default TCI selection rules as a function of a time delay being less than a threshold, where the time delay may be referred to as the time between one or more of: the first DCI, the second DCI, the common data part, and/or the private data part. In examples, the WTRU may monitor for (e.g., both) the first and/or second DCI on USS, where (e.g., both) the first DCI and/or the second DCI may be scrammed with WTRU-specific RNTIs. In one or more scenarios, the network may (e.g., only) schedule a common data part for the WTRU without a private data part. If there is no private data part, for example, to save WTRU power/complexity of blind decoding the second DCI, one or more examples may include dynamically indicating to the WTRU the presence of a second DCI for the private data part. The first DCI may include an indicator (e.g., a bit), and/or the WTRU may determine to monitor for the second DCI as a function of the indicator. If the indicator is 1, for example, the WTRU may monitor for the second DCI; if the indicator is 0, for example, the WTRU may not be expected to monitor for the second DCI.

A WTRU may be configured with a group RNTI for common messages reception and/or may use its private C-RNTI for the private messages' reception. Upon reception and/or decoding of WTRU C-RNTI scrambled DCI, for example, the WTRU may be indicated through this DCI one or more (e.g. any) combinations of the following indicators. The WTRU may be indicated through DCI the common message presence and/or the group RNTI scrambled code word. The WTRU may be indicated through DCI the layer(s) indicator mapping for the common message and/or private message. The WTRU may be indicated through DCI the DMRS sequence associated to the first and/or second codewords (e.g., common and/or private messages). Additionally or alternatively, if the DMRS sequences between the common and private messages are CDM-ed, the second one may (e.g., need to) be indicated). The WTRU may be indicated through DCI the TCIs (e.g., there may be two TCIs) associated with the first and/or second codewords and/or common word layer(s) and/or private word layers.

If the WTRU indicates in its capabilities that it is capable of multi-RX simultaneous reception, simultaneous reception with two special filters may be possible, and/or a pair of TCIs can be signaled in the scheduled DCI. If the WTRU is not supporting one or more (e.g., multiple) simultaneous Rx reception, and/or the network signals two TCIs, the common message linked TCI may be used by the WTRU for private message reception (e.g., as well).

Embodiments described herein may include hybrid automatic repeat request (HARQ)/code block group (CBG) operation for common and/or private data messages. A WTRU may demodulate and/or decode common and/or private messages. When a codeblocks in common messages have NACK, the WTRU may receive a transmission for (e.g., both) common and/or private messages. When codeblocks in common message habe ACK, the WTRU may send ACK/NACK for codeblocks in private message. If codeblocks in private messages have NACK, the WTRU may receive a transmission for (e.g., both) common and/or private messages. When CBG is configured, for example, the WTRU may send ACK/NACK (e.g., only) for codeblocks in private message. For example, the WTRU may receive configuration information. The WTRU may receive the configuration information via RRC (e.g., a RRC message). The configuration information may include a first configuration and/or a second configuration. The first configuration may be associated with reception of common messages of rate splitting-based (RS-based) transmission. The second configuration may be associated with reception of WTRU-specific messages of RS-based transmission. The first configuration may indicate CBGs information associated with the common messages of RS-based transmission. The second configuration may indicate CBG information associated with the WTRU-specific messages of RS-based transmission. The WTRU may transmit hybrid automatic repeat request (HARQ) feedback for the downlink transmission. The HARQ feedback may include at least one of HARQ feedback for the RS-based common message sent in accordance with the CBG information associated with the common messages indicated in the first configuration and/or HARQ feedback for the RS-based WTRU-specific message sent in accordance with the CBG information associated with the WTRU-specific messages indicated in the second configuration. The WTRU may transmit feedback (e.g., HARQ feedback) via one or more physical channels (e.g., physical uplink control channel (PUCCH), physical uplink shared channel (PUSCH)).

HARQ may be employed (e.g., in NR) to provide reliability to the transmitted data. When a WTRU receives data, it may perform error checking. If an error is detected, the WTRU may respond with a NACK, which may prompt the gNB to retransmit the erroneous data. On successful reception, the WTRU may send an ACK. HARQ can use chase combining (e.g., where the exact same data may be sent again) and/or incremental redundancy (e.g., where additional redundancy bits may be sent) to enhance the chances of successful reception. By using the RS approach, for example, the gNB can serve one or more (e.g., multiple) users (e.g., effectively), while HARQ may ensure that one or more (e.g., any) errors in transmitting (e.g., both) common and/or private messages can be (e.g., promptly) dealt with. This may mean that if a user in the group does not receive the common message correctly, the HARQ protocol may trigger a retransmission, which may allow for (e.g., more) efficient utilization of the same resources without resending (e.g., all) group data. The integration of HARQ feedback processes may allow for real-time adjustments. Based on (e.g., after) receiving ACK/NAC messages from users, the gNB can adapt the subsequent transmission(s) accordingly, for example, by (e.g., either) (re)allocating resources and/or by changing the precoding strategy based on channel feedback. If a specific user experiences poor reception, for example, the gNB can adjust the power and/or change the precoding scheme for the private message directed toward that user. By deploying HARQ in conjunction with the RS approach, for example, the network can maintain a (e.g., high) level of reliability, as it can recover from errors in the common message that affects one or more (e.g., multiple) users. If one or more (e.g., some) users report issues with the common message, HARQ may allow for retransmissions without affecting the (e.g., entire) group. For example, a scenario may include one or more (e.g., several) WTRUs are receiving a common music stream (e.g., common message) while also engaged in individual conversations (e.g., private messages). If one WTRU encounters a poor connection (e.g., indicating this via NACK), HARQ may allow the gNB to resend (e.g., only) the problematic portion of the common stream. Simultaneously, the WTRU's response regarding channel conditions can lead to adaptive adjustments in resource allocation, which may ensure that other WTRUs continue to receive (e.g., high-quality) streams while addressing the needs of the one (s) facing issues. The combination of HARQ and CBG may enable more adaptive response capabilities from the network. When feedback is provided by the WTRUs regarding their reception quality, the gNB can adjust the common and/or private messages (e.g., dynamically) to cater to (e.g., both) group performance and/or individual user needs. A WTRU may perform one or more of the following.

When codeblocks in common messages in the common transport block have NACK, the WTRU may request and/or receive a transmission for (e.g., both) common and/or private messages, for example, since the WTRU may not be able to decode the private messages in the private transport block without receiving the common messages and/or performing SIC. One transport block may be divided into two transport blocks including one common transport block and/or one private transport block.

FIG. 12 depicts an example of when the WTRU sends NACK for common transport block(s) 1200. The WTRU may (e.g., first) decode the common transport block. If the WTRU sends NACK for this common transport block, as shown in FIG. 12, the WTRU may receive another (e.g., new) transport block with the other (e.g., new) common and/or private transport blocks. For example, the WTRU may not receive private transport block if the common transport block is not successfully received.

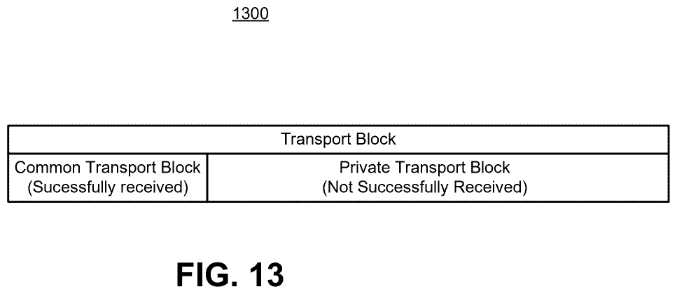

FIG. 13 depicts an example of when a WTRU sends ACK for common transport blocks and NACK for private transport blocks 1300. If the WTRU sends ACK for this common transport block, the WTRU may receive the private transport block(s) associated to the common transport block. If the WTRU sends NACK for this private transport block, as shown in FIG. 13, the WTRU may receive the same private transport block.

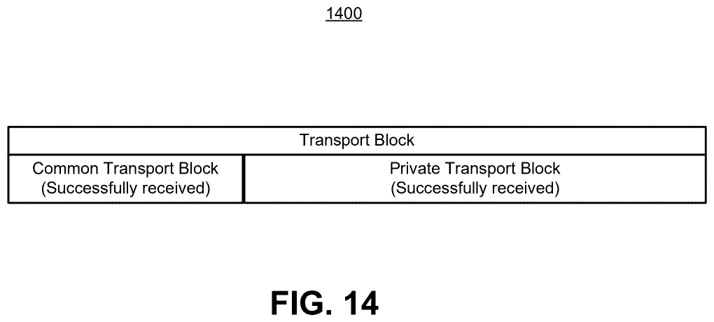

FIG. 14 depicts an example of when the WTRU sends ACK for common and private transport blocks 1400. If the WTRU sends ACK for this private transport block, as shown in FIG. 14, the WTRU can decode both common and private messages.

If codeblocks in private messages have NACK, the WTRU may receive a transmission for both common and private messages. Additionally or alternatively, the WTRU may receive a transmission for (e.g., only) private messages.

When CBG is configured, the WTRU may be configured with a number of codeblocks in common transport block

$$( e . g . , {N}_{CBG}^{c} )$$

and/or a number of codeblocks in private transport blocks

$$( e . g . , {N}_{CBG}^{p} )$$

where

$${N}_{CBG}^{c} = \{ 2 , 4 , 6 , 8 \} and / or {N}_{CBG}^{p} = \{ 2 , 4 , 6 , 8 \} .$$

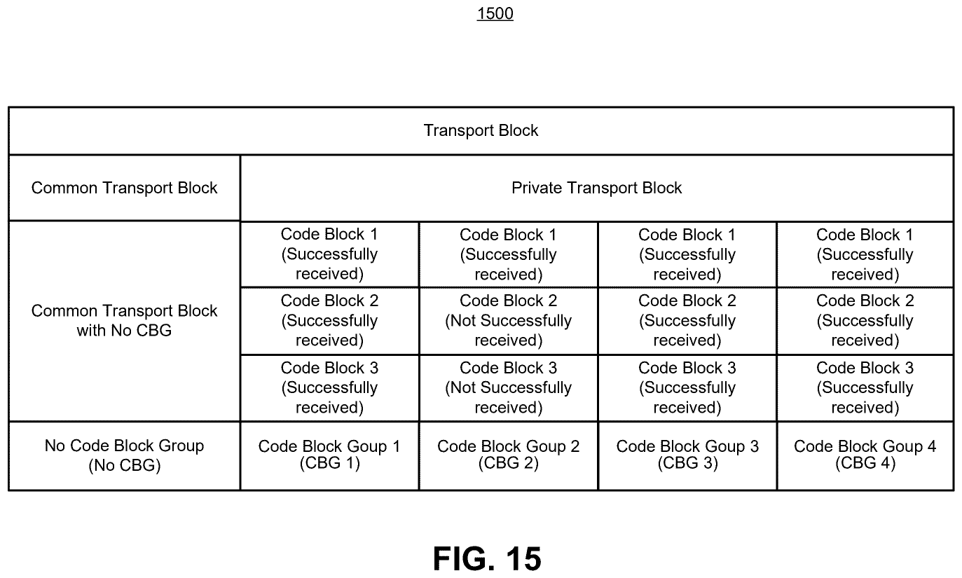

FIG. 15 depicts an example of when CBG is configured for private codeblock groups 1500. For example, a WTRU may be configured with 4 codeblocks (e.g., only) in private transport blocks, as shown in FIG. 15. In examples, the large transport block may be divided into one or more (e.g., four) CBGs, with each CBG having three smaller codeblocks each, CBGs 1, 3, and/or 4 may have passed CRC and/or ACKed; CBG 2 may have CRC failed for code block 2 and 3, and/or a NACK may be sent. As per the process, for example, the gNB may (e.g., only) re-transmit the failed CBG2, not the entire large private transport block.

In examples, a WTRU may be configured with

$${N}_{CBG}^{c}$$

codeblocks in common transport blocks, which may be different with and

$${N}_{CBG}^{p}$$

codeblocks in private transport blocks

$$\begin{matrix}( e . g . , {N}_{CBG}^{c} = 2 codeblocks \\ and / or {N}_{CBG}^{p} = 6 codeblocks ) .\end{matrix}$$

In examples, if the WTRU is configured with more than 4 layers, the maximum number of codeblocks in common transport block,

$${N}_{CBG}^{c}$$

may be limited to 4, e.g.,

$${N}_{CBG}^{c} = \{ 2 , 4 \}$$

and/or the maximum number of codeblocks in private transport blocks, e.g.,

$${N}_{CBG}^{p} ,$$

may be limited to 4, e.g.,

$$\begin{matrix}{N}_{CBG}^{c} = \\ \{ 2 , 4 \} .\end{matrix}$$

When CBG is configured, the gNB may (e.g., also) use the PDSCH-ServingCellConfig parameter structure to configure the use of the CBG Flush Indicator (CBGFI) field within DCI for (e.g., both) the common and/or the private messages. When included, this field may be a single bit which can be used as a flag to instruct the WTRU to empty its soft combining buffers for one or more (e.g., all) CBGs included within the PDSCH transmission.

A base station may receive capability information from a wireless transmit/receive unit (WTRU). The capability information may include an indication of a maximum number of rate splitting multiple access (RSMA) layers and/or an indication of a maximum number of multiple input multiple output (MIMO) layers per RSMA layer. The base station may send configuration information to the WTRU. The configuration information may include comprises a first configuration and a second configuration. The first configuration may be associated with reception of common messages of rate splitting-based (RS-based) transmission. The second configuration may be associated with reception of WTRU-specific messages of RS-based transmission. The first configuration may indicate code block groups (CBGs) information associated with the common messages of RS-based transmission. The second configuration indicates CBG information may be associated with the WTRU-specific messages of RS-based transmission. The base station may send a downlink transmission to the WTRU. The downlink transmission may include at least one of a RS-based common message in accordance with the first configuration and/or a RS-based WTRU-specific message in accordance with the second configuration. The base station may receive hybrid automatic repeat request (HARQ) feedback for the downlink transmission. The HARQ feedback may include at least one of HARQ feedback for the RS-based common message sent in accordance with the CBG information associated with the common messages indicated in the first configuration and/or HARQ feedback for the RS-based WTRU-specific message sent in accordance with the CBG information associated with the WTRU-specific messages indicated in the second configuration.

1. A wireless transmit/receive unit (WTRU) comprising:
a processor configured to:
send capability information to a network, wherein the capability information comprises an indication of a maximum number of rate splitting multiple access (RSMA) layers and an indication of a maximum number of multiple input multiple output (MIMO) layers per RSMA layer;
receive configuration information, wherein the configuration information comprises a first configuration and a second configuration, wherein the first configuration is associated with reception of common messages of rate splitting-based (RS-based) transmission, and wherein the second configuration is associated with reception of WTRU-specific messages of RS-based transmission, and wherein the first configuration indicates code block groups (CBGs) information associated with the common messages of RS-based transmission, and wherein the second configuration indicates CBG information associated with the WTRU-specific messages of RS-based transmission;
receive a downlink transmission comprising at least one of a RS-based common message in accordance with the first configuration or a RS-based WTRU-specific message in accordance with the second configuration; and
transmit hybrid automatic repeat request (HARQ) feedback for the downlink transmission, wherein the HARQ feedback comprises at least one of HARQ feedback for the RS-based common message sent in accordance with the CBG information associated with the common messages indicated in the first configuration or HARQ feedback for the RS-based WTRU-specific message sent in accordance with the CBG information associated with the WTRU-specific messages indicated in the second configuration.

2. The WTRU of claim 1, wherein the RS-based common message comprises a plurality of CBGs formatted in accordance with the CBG information associated with the common message indicated in the first configuration and/or the RS-based WTRU-specific message comprises a plurality of CBGs formatted in accordance with the CBG information associated with the WTRU-specific messages indicated in the second configuration.

3. The WTRU of claim 1, wherein the configuration information comprises scheduling configuration information, and wherein the processor is configured to determine an allocation of time and frequency resources based on the scheduling configuration information for each of the RS-based common message and RS-based WTRU-specific message, and wherein the downlink transmission is received in accordance with the allocation of time and frequency resources.

4. The WTRU of claim 1, wherein the configuration information comprises scheduling configuration information, and wherein the processor is configured to determine a first transmission rank associated with the common messages of RS-based transmission, a first modulation and coding-rate associated with the common messages of RS-based transmission, a second transmission rank associated with the WTRU-based messages of RS-based transmission, and a second modulation and coding-rate associated with the WTRU-specific messages of RS-based transmission, and wherein the downlink transmission is received in accordance with one or more of the first transmission rank, the second transmission rank, the first modulation and coding-rate, or the second modulation and coding-rate.

5. The WTRU of claim 4, wherein the processor is configured to:
receive an indication indicating to update an initially configured power offset; and
update the initially configured power offset based on the indication.

6. The WTRU of claim 1, wherein the configuration information comprises a configuration for a demodulation reference signal (DMRS) sequence, wherein the DMRS sequence comprises configuration for a first DMRS sequence and a configuration for a second DMRS sequence, wherein the first DMRS sequence is associated with the common messages of RS-based transmission, and wherein the second DMRS sequence is associated with the WTRU-specific messages of RS-based transmission, and wherein the downlink transmission is received based on the first DMRS sequence or the second DMRS sequence.

7. The WTRU of claim 6, wherein the configuration information comprises a first DMRS initialization sequence and a second DMRS initialization sequence, wherein the processor is configured to use the first DMRS initialization sequence to receive the RS-based common message, and wherein the processor is configured to use the second DMRS initialization sequence to receive the RS-based WTRU-specific message.

8. The WTRU of claim 1, wherein the configuration information comprises a radio network temporary identifier (RNTI), wherein the RNTI comprises a first RNTI and a second RNTI, wherein the first RNTI is associated with the common messages of RS-based transmission, and wherein the second RNTI is associated with the WTRU-specific messages of RS-based transmission, and wherein the downlink transmission is received based on the first RNTI or the second RNTI.

9. The WTRU of claim 1, wherein the processor is configured to use different spatial filters to receive the RS-based common message or the RS-based WTRU-specific message.

10. The WTRU of claim 1, wherein the processor is configured to receive a retransmission of the downlink transmission based on a determination that at least the common messages of RS-based transmission were not successfully received.

11. A method performed by a wireless transmit/receive unit (WTRU), the method comprising:
sending capability information to a network, wherein the capability information comprises an indication of a maximum number of rate splitting multiple access (RSMA) layers and an indication of a maximum number of multiple input multiple output (MIMO) layers per RSMA layer;
receiving configuration information, wherein the configuration information comprises a first configuration and a second configuration, wherein the first configuration is associated with reception of common messages of rate splitting-based (RS-based) transmission, and wherein the second configuration is associated with reception of WTRU-specific messages of RS-based transmission, and wherein the first configuration indicates code block groups (CBGs) information associated with the common messages of RS-based transmission, and wherein the second configuration indicates CBG information associated with the WTRU-specific messages of RS-based transmission;
receiving a downlink transmission comprising at least one of a RS-based common message in accordance with the first configuration or a RS-based WTRU-specific message in accordance with the second configuration; and
transmitting hybrid automatic repeat request (HARQ) feedback for the downlink transmission, wherein the HARQ feedback comprises at least one of HARQ feedback for the RS-based common message sent in accordance with the CBG information associated with the common messages indicated in the first configuration or HARQ feedback for the RS-based WTRU-specific message sent in accordance with the CBG information associated with the WTRU-specific messages indicated in the second configuration.

12. The method of claim 11, wherein the RS-based common message comprises a plurality of CBGs formatted in accordance with the CBG information associated with the common message indicated in the first configuration and/or the RS-based WTRU-specific message comprises a plurality of CBGs formatted in accordance with the CBG information associated with the WTRU-specific messages indicated in the second configuration.

13. The method of claim 11, wherein the configuration information comprises scheduling configuration information, and wherein the method further comprising determining an allocation of time and frequency resources based on the scheduling configuration information for each of the RS-based common message and the RS-based WTRU-specific message, and wherein the downlink transmission is received in accordance with the allocation of time and frequency resources.

14. The method of claim 11, wherein the configuration information comprises scheduling configuration information, and wherein the method further comprising determining a first transmission rank associated with the common messages of RS-based transmission, a first modulation and coding-rate associated with the common messages of RS-based transmission, a second transmission rank associated with the WTRU-based messages of RS-based transmission, and a second modulation and coding-rate associated with the WTRU-specific messages of RS-based transmission, and wherein the downlink transmission is received in accordance with one or more of the first transmission rank, the second transmission rank, the first modulation and coding-rate, or the second modulation and coding-rate.

15. The method of claim 11, further comprising:
receiving an indication indicating to update an initially configured power offset; and
updating the initially configured power offset based on the indication.

16. The method of claim 11, wherein the configuration information comprises a configuration for a demodulation reference signal (DMRS) sequence, wherein the DMRS sequence comprises configuration for a first DMRS sequence and configuration for a second DMRS sequence, wherein the first DMRS sequence is associated with the common messages of RS-based transmission, and wherein the second DMRS sequence is associated with the WTRU-specific messages of RS-based transmission, and wherein the downlink transmission is received based on the first DMRS sequence or the second DMRS sequence.

17. The method of claim 16, wherein the configuration information comprises a first DMRS initialization sequence and a second DMRS initialization sequence, wherein the RS-based common message is received using the first DMRS initialization sequence, and wherein the RS-based WTRU-specific message is received using the second DMRS initialization sequence.

18. The method of claim 11, wherein the configuration information comprises a radio network temporary identifier (RNTI), wherein the RNTI comprises a first RNTI and a second RNTI, wherein the first RNTI is associated with the common messages of RS-based transmission, and wherein the second RNTI is associated with the WTRU-specific messages of RS-based transmission, and wherein the downlink transmission is received based on the first RNTI or the second RNTI.

19. The method of claim 11, further comprising using on different spatial filters to receive the RS-based common message or the RS-based WTRU-specific message.

20. The method of claim 11, further comprising receiving a retransmission of the downlink transmission based on a determination that at least the common messages of RS-based transmission were not successfully received.

21. A wireless transmit/receive unit (WTRU) comprising:
a processor configured to:
send capability information to a network, wherein the capability information comprises an indication of a maximum number of rate splitting multiple access (RSMA) layers and an indication of a maximum number of multiple input multiple output (MIMO) layers per RSMA layer;
receive configuration information, wherein the configuration information comprises a first configuration and a second configuration, wherein the first configuration is associated with reception of common messages of rate splitting-based (RS-based) transmission, and wherein the second configuration is associated with reception of WTRU-specific messages of RS-based transmission; and
receive a downlink transmission comprising at least one of a RS-based common message in accordance with the first configuration or a RS-based WTRU-specific message in accordance with the second configuration.

22. A method performed by a wireless transmit/receive unit (WTRU), the method comprising:
sending capability information to a network, wherein the capability information comprises an indication of a maximum number of rate splitting multiple access (RSMA) layers and an indication of a maximum number of multiple input multiple output (MIMO) layers per RSMA layer;
receiving configuration information, wherein the configuration information comprises a first configuration and a second configuration, wherein the first configuration is associated with reception of common messages of rate splitting-based (RS-based) transmission, and wherein the second configuration is associated with reception of WTRU-specific messages of RS-based transmission; and
receiving a downlink transmission comprising at least one of a RS-based common message in accordance with the first configuration or a RS-based WTRU-specific message in accordance with the second configuration.

23. A base station comprising:
a transceiver; and
a processor configured to:
receive, via the transceiver, capability information from a wireless transmit/receive unit (WTRU), wherein the capability information comprises an indication of a maximum number of rate splitting multiple access (RSMA) layers and an indication of a maximum number of multiple input multiple output (MIMO) layers per RSMA layer;
send, via the transceiver, configuration information to the WTRU, wherein the configuration information comprises a first configuration and a second configuration, wherein the first configuration is associated with reception of common messages of rate splitting-based (RS-based) transmission, and wherein the second configuration is associated with reception of WTRU-specific messages of RS-based transmission, and wherein the first configuration indicates code block groups (CBGs) information is associated with the common messages of RS-based transmission, and wherein the second configuration indicates CBG information associated with the WTRU-specific messages of RS-based transmission;
send, via the transceiver, a downlink transmission to the WTRU, wherein the downlink transmission comprises at least one of a RS-based common message in accordance with the first configuration or a RS-based WTRU-specific message in accordance with the second configuration; and
receive, via the transceiver from the WTRU, hybrid automatic repeat request (HARQ) feedback for the downlink transmission, wherein the HARQ feedback comprises at least one of HARQ feedback for the RS-based common message sent in accordance with the CBG information associated with the common messages indicated in the first configuration or HARQ feedback for the RS-based WTRU-specific message sent in accordance with the CBG information associated with the WTRU-specific messages indicated in the second configuration.

24. A base station comprising:
a transceiver; and
a processor configured to:
receive capability information from a wireless transmit/receive unit (WTRU), wherein the capability information comprises an indication of a maximum number of rate splitting multiple access (RSMA) layers and an indication of a maximum number of multiple input multiple output (MIMO) layers per RSMA layer;
send configuration information, wherein the configuration information comprises a first configuration and a second configuration, wherein the first configuration is associated with reception of common messages of rate splitting-based (RS-based) transmission, and wherein the second configuration is associated with reception of WTRU-specific messages of RS-based transmission; and
send a downlink transmission comprising at least one of a RS-based common message in accordance with the first configuration or a RS-based WTRU-specific message in accordance with the second configuration.
